(19) United States
(12) Patent Application Publication
(10) Pub. No.: US 2025/0203519 A1
(43) Pub. Date: Jun. 19, 2025

(54) METHODS FOR SYSTEM INFORMATION ACQUISITION FOR MULTIPATH WTRU TO NW RELAYS

(71) Applicant: INTERDIGITAL PATENT HOLDINGS, INC., Wilmington, DE (US)

(72) Inventors: Martino Freda, Laval (CA); Oumer Teyeb, Montreal (CA); Tuong Hoang, Montreal (CA); Moon IL Lee, Melville, NY (US); Paul Marinier, Brossard (CA)

(73) Assignee: INTERDIGITAL PATENT HOLDINGS, INC., Wilmington, DE (US)

(21) Appl. No.: 18/837,440

(22) PCT Filed: Feb. 9, 2023
(86) PCT No.: PCT/US2023/012708

§ 371 Date: Aug. 9, 2024

Related U.S. Application Data
(60) Provisional application No. 63/308,355, filed on Feb. 9, 2022.
(60) Provisional application No. 63/326,632, filed on Apr. 1, 2022.
(60) Provisional application No. 63/421,894, filed on Nov. 2, 2022.

(51) Int. Cl. H04W 52/02; H04W 88/04

(52) U.S. Cl. CPC H04W 52/0235; H04W 52/0225; H04W 88/04

(57) ABSTRACT

The present system and method includes a relay WTRU that determines whether to forward SI to a remote WTRU following request by the remote WTRU based on the coverage/capability indicated by the remote WTRU and the RRC state of the relay WTRU. The present system and method includes the remote WTRU determines whether to request/receive SI from the network or relay based on Uu quality, SI request configuration (msg1 or msg3-based), and indication from the relay following SI request. The present system and method includes the relay, following reception of a new sib, may indicate to the network whether a sib may be provided in dedicated signaling or broadcast.

### CROSS-REFERENCE TO RELATED APPLICATIONS

This application claims the benefit of U.S. Provisional Application No. 63/308,355, filed Feb. 9, 2022, and U.S. Provisional Application No. 63/326,632, filed Apr. 1, 2022, and U.S. Provisional Application No. 63/421,894, filed Nov. 2, 2022, which are incorporated by reference as if fully set forth.

### BACKGROUND

Sidelink Relay, which may be regarded as an evolvement of D2D (Device-to-Device) technology developed in LTE, has a wide application scenario. In order to access the evolved technology of Sidelink Relays, and other NR relays, it is necessary to provide a method and system for system information acquisition for multipath WTRU to NW relays.

### SUMMARY

The present system and method includes a relay WTRU that determines whether to forward SI to a remote WTRU following request by the remote WTRU based on the coverage/capability indicated by the remote WTRU and the RRC state of the relay WTRU. The relay WTRU receives capability information related to whether the remote WTRU supports multipath from a remote WTRU in PC5-RRC capability exchange, receives an SI request from a remote WTRU containing a coverage indication (IC/OOC), requests the corresponding SI from the network, and if the requesting remote WTRU supports multipath and indicates IC in the request and the relay WTRU is in RRC_IDLE/RRC_INACTIVE, the relay WTRU, upon receiving indication that the SI request was transmitted, sends an indication to the remote WTRU that the requested SI may be obtained directly on Uu, otherwise (Legacy remote WTRU, OOC remote WTRU, or relay WTRU in RRC_CONNECTED) and the relay WTRU obtains the requested SI and sends it to the remote WTRU (via PC5-RRC).

The present system and method includes the remote WTRU determines whether to request/receive SI from the network or relay based on Uu quality, SI request configuration (MSG1 or MSG3-based), and indication from the relay following SI request. The remote WTRU configured in multipath receives a Uu quality threshold for sending SI request via Uu directly, receives a Uu quality threshold for receiving SI via Uu, receives an SI request config from SIB1 indicating MSG1-based or MSG3-based SI request, and if the Uu quality is above threshold for sending the SI request and the WTRU is configured for MSG1-based SI request, sends the SI request via Uu and receives the requested SI via Uu, otherwise computes an IC/OOC indication based on whether the measured Uu quality is above/below the SI receiving via Uu threshold, sends the SI request to the relay WTRU, including a computed IC/OOC indication, and if the relay WTRU indicates to receive the SI via Uu, receives the requested SI via Uu, otherwise, receives the requested SI via the relay WTRU.

The present system and method includes the relay, following reception of a new SIB, may indicate to the network whether a SIB may be provided in dedicated signaling or broadcast. The relay WTRU receives a PC5-RRC message from the remote WTRU enabling/disabling SI forwarding via SL, receives a SI requests from a remote WTRU, upon reception by the relay WTRU of a new SIB or an SI update notification for an updated SI required by at least one remote WTRU. For a relay WTRU in RRC_CONNECTED, if the relay is configured on a BWP without CSS and at least one relay WTRU has SIB forwarding disabled via SL, sends a dedicatedSIBRequest indicating SIB may be broadcast, otherwise sends legacy dedicatedSIBRequest. For a relay WTRU in RRC_IDLE/RRC_INACTIVE, sends SI request to the network, if at least one relay WTRU has SIB forwarding enabled via SL, forwards the SI to the remote WTRU.

Disclosed is a system and method for a WTRU. The system and method include receiving information, the information including a direct path quality threshold for sending a system information (SI) request via the direct path, a direct path quality threshold for receiving SI via the direct path, and an SI request configuration indicating a configuration of the SI request, measuring a quality of the direct path, and based on the measured direct path quality being below the direct path quality threshold for sending a SI request via the direct path and the SI request configuration indicating a MSG3-based SI request: determining an indication based on whether the measured the direct path quality is above/below the direct path quality threshold for receiving SI via the direct path, sending the SI request via a relay WTRU, the SI request including the indication, and receiving SI via the relay WTRU or via the direct path depending on an indication from the relay WTRU.

Disclosed is a system and method for a WTRU. The system and method include receiving information, the information including a direct path quality threshold for sending a system information (SI) request via the direct path, a direct path quality threshold for receiving SI via the direct path, and an SI request configuration indicating a configuration of the SI request, measuring a quality of the direct path, and based on the measured direct path quality being above the direct path quality threshold for sending a SI request via the direct path or the SI request configuration indicating a MSG1-based SI request: sending the SI request via the direct path, and receiving the requested SI via the direct path.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed examples may be implemented;

FIG. 1B is a system diagram illustrating an example wireless transmit/receive unit (WTRU) that may be used within the communications system illustrated in FIG. 1A according to an example;

FIG. 1C is a system diagram illustrating an example radio access network (RAN) and an example core network (CN) that may be used within the communications system illustrated in FIG. 1A according to an example;

FIG. 1D is a system diagram illustrating a further example RAN and a further example CN that may be used within the communications system illustrated in FIG. 1A according to an example;

FIG. 2 illustrates a user plane radio protocol stack for layer 2 evolved WTRU-to-Network relay (PC5);

FIG. 3 illustrates a control plane radio protocol stack for layer 2 evolved WTRU-to-Network relay (PC5);

FIG. 4 illustrates a method associated with receiving an indication from a remote WTRU enabling or disabling SI forwarding; and

FIG. 5 illustrates a method associated with the IC remote WTRU requesting SI and a relay WTRU provides SI.

### DETAILED DESCRIPTION

The present system and method includes a relay WTRU that determines whether to forward SI to a remote WTRU following request by the remote WTRU based on the coverage/capability indicated by the remote WTRU and the RRC state of the relay WTRU. The relay WTRU receives capability information related to whether the remote WTRU supports multipath from a remote WTRU in PC5-RRC capability exchange, receives an SI request from a remote WTRU containing a coverage indication (IC/OOC), requests the corresponding SI from the network, and if the requesting remote WTRU supports multipath and indicates IC in the request and the relay WTRU is in RRC_IDLE/RRC_INACTIVE, the relay WTRU, upon receiving indication that the SI request was transmitted, sends an indication to the remote WTRU that the requested SI may be obtained directly on Uu, otherwise (Legacy remote WTRU, OOC remote WTRU, or relay WTRU in RRC_CONNECTED) and the relay WTRU obtains the requested SI and sends it to the remote WTRU (via PC5-RRC).

The present system and method includes the remote WTRU determines whether to request/receive SI from the network or relay based on Uu quality, SI request configuration (MSG1 or MSG3-based), and indication from the relay following SI request. The remote WTRU configured in multipath receives a Uu quality threshold for sending SI request via Uu directly, receives a Uu quality threshold for receiving SI via Uu, receives an SI request config from SIB1 indicating MSG1-based or MSG3-based SI request, and if the Uu quality is above threshold for sending the SI request and the WTRU is configured for MSG1-based SI request, sends the SI request via Uu and receives the requested SI via Uu, otherwise computes an IC/OOC indication based on whether the measured Uu quality is above/below the SI receiving via Uu threshold, sends the SI request to the relay WTRU, including a computed IC/OOC indication, and if the relay WTRU indicates to receive the SI via Uu, receives the requested SI via Uu, otherwise, receives the requested SI via the relay WTRU.

The present system and method includes the relay, following reception of a new SIB, may indicate to the network whether a SIB may be provided in dedicated signaling or broadcast. The relay WTRU receives a PC5-RRC message from the remote WTRU enabling/disabling SI forwarding via SL, receives a SI requests from a remote WTRU, upon reception by the relay WTRU of a new SIB or an SI update notification for an updated SI required by at least one remote WTRU. For a relay WTRU in RRC_CONNECTED, if the relay is configured on a BWP without CSS and at least one relay WTRU has SIB forwarding disabled via SL, sends a dedicatedSIBRequest indicating SIB may be broadcast, otherwise sends legacy dedicatedSIBRequest. For a relay WTRU in RRC_IDLE/RRC_INACTIVE, sends SI request to the network, if at least one relay WTRU has SIB forwarding enabled via SL, forwards the SI to the remote WTRU.

Disclosed is a system and method for a WTRU. The system and method include receiving information, the information including a direct path quality threshold for sending a system information (SI) request via the direct path, a direct path quality threshold for receiving SI via the direct path, and an SI request configuration indicating a configuration of the SI request, measuring a quality of the direct path, and based on the measured direct path quality being below the direct path quality threshold for sending a SI request via the direct path and the SI request configuration indicating a MSG3-based SI request: determining an indication based on whether the measured the direct path quality is above/below the direct path quality threshold for receiving SI via the direct path, sending the SI request via a relay WTRU, the SI request including the indication, and receiving SI via the relay WTRU or via the direct path depending on an indication from the relay WTRU.

Disclosed is a system and method for a WTRU. The system and method include receiving information, the information including a direct path quality threshold for sending a system information (SI) request via the direct path, a direct path quality threshold for receiving SI via the direct path, and an SI request configuration indicating a configuration of the SI request, measuring a quality of the direct path, and based on the measured direct path quality being above the direct path quality threshold for sending a SI request via the direct path or the SI request configuration indicating a MSG1-based SI request: sending the SI request via the direct path, and receiving the requested SI via the direct path.

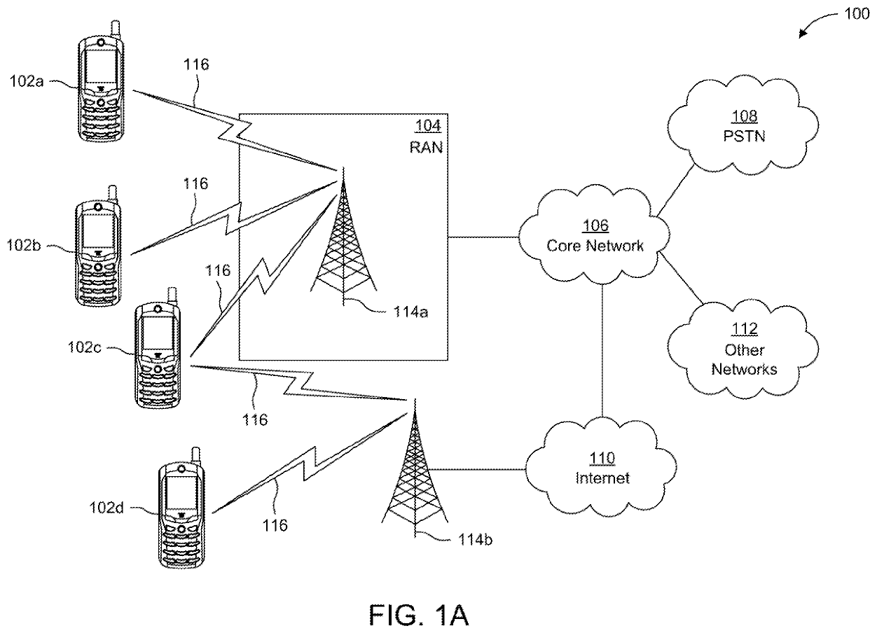

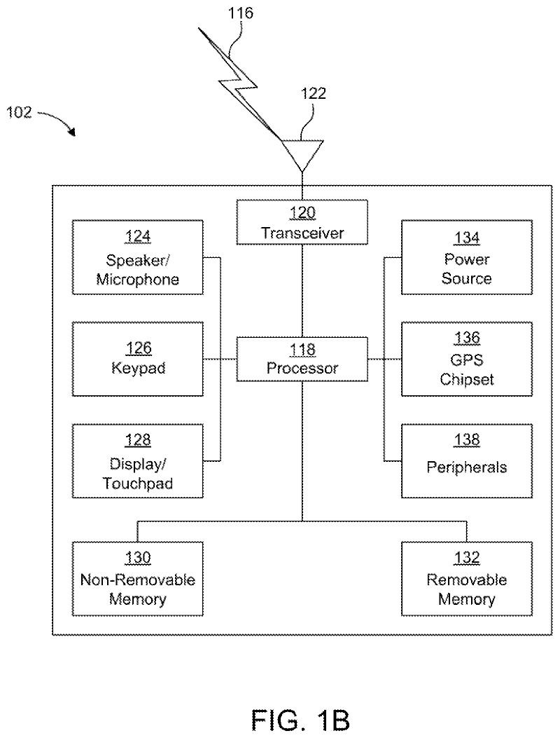

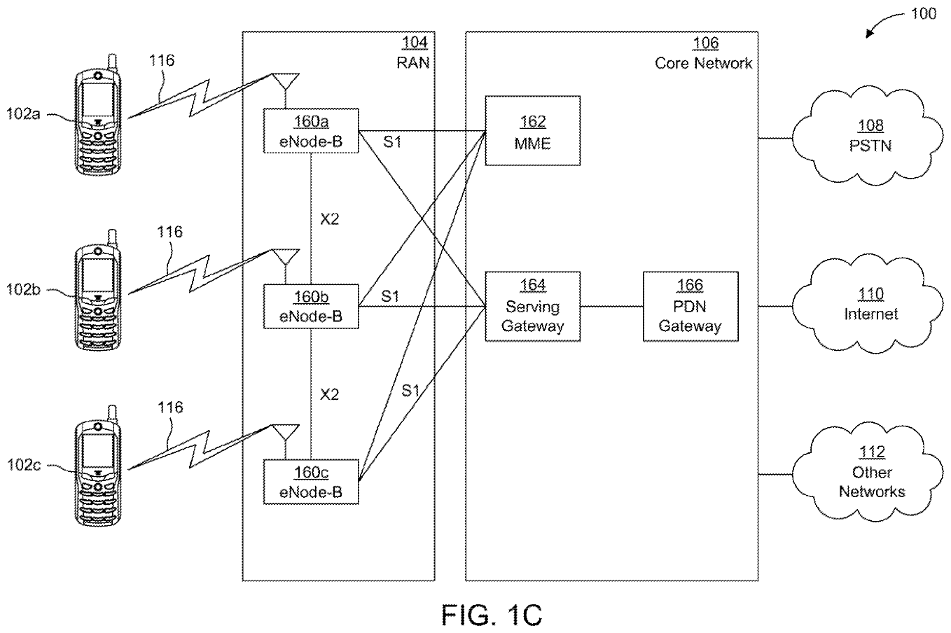

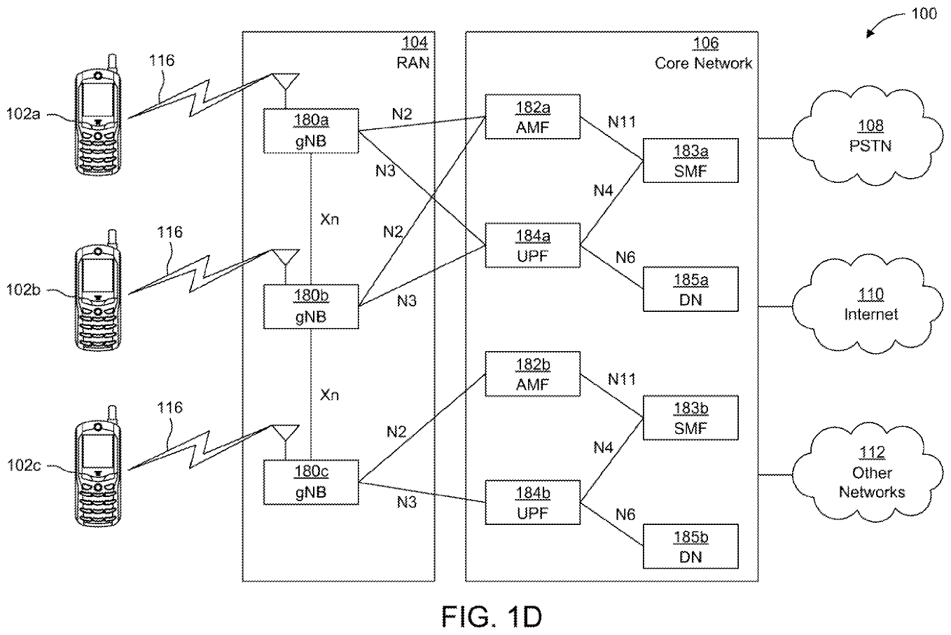

FIG. 1A is a diagram illustrating an example communications system 100 in which one or more disclosed examples may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed examples contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one example, the base station 114a may include three transceivers, i.e., one for each sector of the cell. In an example, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an example, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an example, the base station 114a and the WTRUs 102a, 102b, 102c may implement a radio technology such as NR Radio Access, which may establish the air interface 116 using NR.

In an example, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other examples, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one example, the base station 114b and the WTRUs 102c, 102d may implement a radio technology such as IEEE 802.11 to establish a wireless local area network (WLAN). In an example, the base station 114b and the WTRUs 102c, 102d may implement a radio technology such as IEEE 802.15 to establish a wireless personal area network (WPAN). In yet another example, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QOS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an example.

The processor 118 may be a general-purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one example, the transmit/receive element 122 may be an antenna configured to transmit and/or receive RF signals. In an example, the transmit/receive element 122 may be an emitter/detector configured to transmit and/or receive IR, UV, or visible light signals, for example. In yet another example, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one example, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other examples, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an example.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an example, the WTRU 102 may include a half-duplex radio for which transmission and reception of some or all of the signals (e.g., associated with particular subframes for either the UL (e.g., for transmission) or the DL (e.g., for reception).

FIG. 1C is a system diagram illustrating the RAN 104 and the CN 106 according to an example. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an example. The eNode-Bs 160a, 160b, 160c may each include one or more transceivers for communicating with the WTRUs 102a, 102b, 102c over the air interface 116. In one example, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative examples that such a terminal may use (e.g., temporarily or permanently) wired communication interfaces with the communication network.

In representative examples, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative examples, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative examples, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHZ, 80 MHZ, and/or 160 MHz wide channels. The 40 MHZ, and/or 80 MHZ, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHZ, and 20 MHz bandwidths in the TV White Space (TVWS) spectrum, and 802.11ah supports 1 MHZ, 2 MHZ, 4 MHZ, 8 MHZ, and 16 MHz bandwidths using non-TVWS spectrum. According to a representative example, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHZ, 4 MHZ, 8 MHZ, 16 MHZ, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an example. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an example. The gNBs 180a, 180b, 180c may each include one or more transceivers for communicating with the WTRUs 102a, 102b, 102c over the air interface 116. In one example, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an example, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an example, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a, 184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating WTRU IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one example, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

The NR sidelink may use both WTRU to network relays and WTRU to WTRU relays based on PC5 (sidelink). NR sidelink generally focuses on supporting V2X related road safety services. The design aims to provide support for broadcast, groupcast and unicast communications in both out-of-coverage and in-network coverage scenarios. Sidelink-based relaying functionality may include sidelink/network coverage extension and power efficiency improvement, considering wider range of applications and services.

To further provide coverage extension for sidelink-based communication, WTRU-to-network coverage extension: Uu coverage reachability is necessary for WTRUs to reach server in PDN network or counterpart WTRU out of proximity area. WTRU-to-network relay may be limited to EUTRA-based technology, and thus not effectively applied to NR-based system, for both NG-RAN and NR-based sidelink communication.

WTRU-to-WTRU coverage extension: Currently proximity reachability is limited to single-hop sidelink link, either via EUTRA-based or NR-based sidelink technology. However, that may not be sufficient in the scenario where there is no Uu coverage, considering the limited single-hop sidelink coverage.

Overall, sidelink connectivity may be extended in NR framework, in order to support the enhanced QoS requirements, which may include single hopping NR sidelink relays. These single hopping NR sidelink relays may include minimum specification impact to support the SA requirements for sidelink-based WTRU-to-network and WTRU-to-WTRU relay, focusing on the following aspects (if applicable) for layer-3 relay and layer-2 relay [RAN2]; relay (re-) selection criterion and procedure; relay/remote WTRU authorization; QoS for relaying functionality; service continuity; security of relayed connection after SA3 has provided its conclusions; impact on user plane protocol stack and control plane procedure, e.g., connection management of relayed connection; and study mechanism(s) to support upper layer operations of discovery model/procedure for sidelink relaying, assuming no new physical layer channel/signal [RAN2]. The system and method may account for further input from SA WGs, e.g., SA2 and SA3, and the elements described herein. The WTRU-to-network relay and WTRU-to-WTRU relay may use the same relaying solution. Forward compatibility for multi-hop relay support may be accounted for. For layer-2 WTRU-to-network relay, the architecture of end-to-end PDCP and hop-by-hop RLC, may be defined.

Relaying via ProSe WTRU to Network relays may extend network coverage to an out of coverage WTRU by using PC5 (D2D) between an out of coverage WTRU and a WTRU-to-Network relay. For example, a ProSe WTRU-to-Network Relay provides a generic L3 forwarding function that may relay any type of IP traffic between the Remote WTRU and the network. One-to-one and one-to-many sidelink communications are used between the Remote WTRU(s) and the ProSe WTRU-to-Network Relay. For both Remote WTRU and Relay WTRU one single carrier (i.e., Public Safety ProSe Carrier) operation may be supported (i.e., Uu and PC5 may be same carrier for Relay/Remote WTRU). The Remote WTRU is authorized by upper layers and may be in-coverage of the Public Safety ProSe Carrier or out-of-coverage on any supported carriers including Public Safety ProSe Carrier for WTRU-to-Network Relay discovery, (re) selection and communication. The ProSe WTRU-to-Network Relay is always in-coverage of EUTRAN. The ProSe WTRU-to-Network Relay and the Remote WTRU perform sidelink communication and sidelink discovery as described.

Relay selection/reselection for ProSe WTRU to NW relays is performed based on combination of a AS layer quality measurements (RSRP) and upper layer criteria. The eNB controls whether the WTRU may act as a ProSe WTRU-to-Network Relay. If the eNB broadcast any information associated to ProSe WTRU-to-Network Relay operation, then ProSe WTRU-to-Network Relay operation is supported in the cell. The eNB may provide: transmission resources for ProSe WTRU-to-Network Relay discovery using broadcast signaling for RRC_IDLE state and dedicated signaling for RRC_CONNECTED state; reception resources for ProSe WTRU-to-Network Relay discovery using broadcast signaling. The eNB may broadcast a minimum and/or a maximum Uu link quality (RSRP) threshold(s) that the ProSe WTRU-to-Network Relay needs to respect before it may initiate a WTRU-to-Network Relay discovery procedure. In RRC_IDLE, when the eNB broadcasts transmission resource pools, the WTRU may use the threshold(s) to autonomously start or stop the WTRU-to-Network Relay discovery procedure. In RRC_CONNECTED, the WTRU uses the threshold(s) to determine if it may indicate to eNB that it is a Relay WTRU and wants to start ProSe WTRU-to-Network Relay discovery. If the eNB does not broadcast transmission resource pools for ProSe WTRU-to-Network Relay discovery, then a WTRU may initiate a request for ProSe-WTRU-to-Network Relay discovery resources by dedicated signaling, respecting these broadcasted threshold(s). If the ProSe-WTRU-to-Network Relay is initiated by broadcast signaling, it may perform ProSe WTRU-to-Network Relay discovery when in RRC_IDLE. If the ProSe WTRU-to-Network Relay is initiated by dedicated signaling, it may perform relay discovery as long as it is in RRC_CONNECTED.

A ProSe WTRU-to-Network Relay performing sidelink communication for ProSe WTRU-to-Network Relay operation has to be in RRC_CONNECTED. After receiving a layer-2 link establishment request or TMGI monitoring request (upper layer message) from the Remote WTRU, the ProSe WTRU-to-Network Relay indicates to the eNB that it is a ProSe WTRU-to-Network Relay and intends to perform ProSe WTRU-to-Network Relay sidelink communication. The eNB may provide resources for ProSe WTRU-to-Network Relay communication.

The remote WTRU may decide when to start monitoring for ProSe WTRU-to-Network Relay discovery. The Remote WTRU may transmit ProSe WTRU-to-Network Relay discovery solicitation messages while in RRC_IDLE or in RRC_CONNECTED depending on the configuration of resources for ProSe WTRU-to-Network Relay discovery. The eNB may broadcast a threshold, which is used by the Remote WTRU to determine if it may transmit ProSe WTRU-to-Network Relay discovery solicitation messages, to connect or communicate with ProSe WTRU-to-Network Relay WTRU. The RRC_CONNECTED Remote WTRU, uses the broadcasted threshold to determine if it may indicate to eNB that it is a Remote WTRU and wants to participate in ProSe WTRU-to-Network Relay discovery and/or communication. The eNB may provide, transmission resources using broadcast or dedicated signaling and reception resources using broadcast signaling for ProSe WTRU-to-Network Relay Operation. The Remote WTRU stops using ProSe WTRU-to-Network Relay discovery and communication resources when RSRP goes above the broadcasted threshold. The exact time of traffic switching from Uu to PC5, or vice versa, may be determined at a higher layer.

The Remote WTRU may perform radio measurements at PC5 interface and may use the measurements for ProSe WTRU-to-Network Relay selection and reselection along with higher layer criterion. A ProSe WTRU-to-Network Relay may be considered suitable in terms of radio criteria if the PC5 link quality exceeds configured threshold (pre-configured or provided by eNB). The Remote WTRU may select the ProSe WTRU-to-Network Relay, which satisfies higher layer criterion and has best PC5 link quality among all suitable ProSe WTRU-to-Network Relays. The Remote WTRU triggers ProSe WTRU-to-Network Relay reselection when: PC5 signal strength of current ProSe WTRU-to-Network Relay is below configured signal strength threshold; It receives a layer-2 link release message (upper layer message) from ProSe WTRU-to-Network Relay.

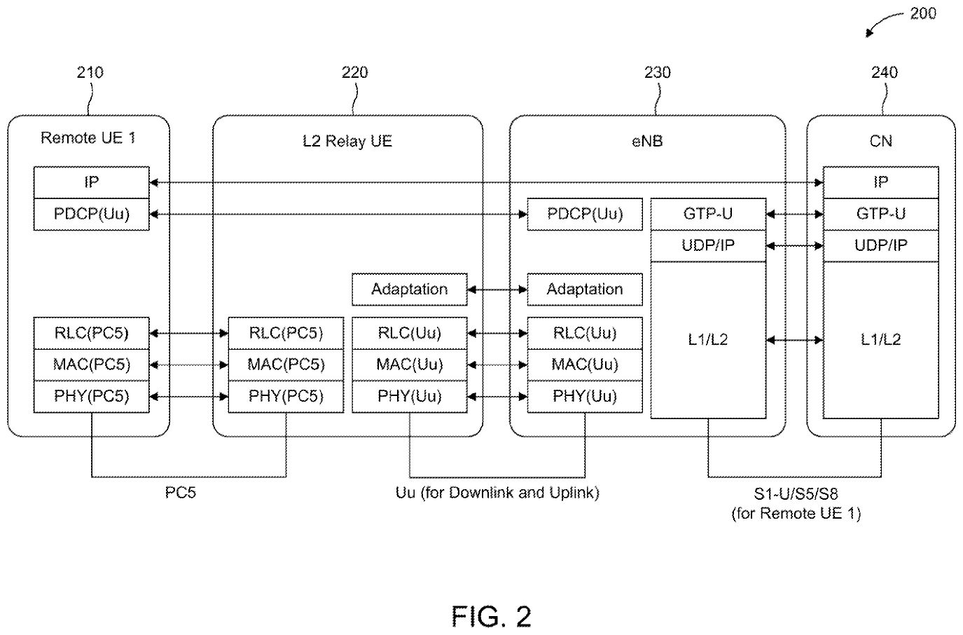

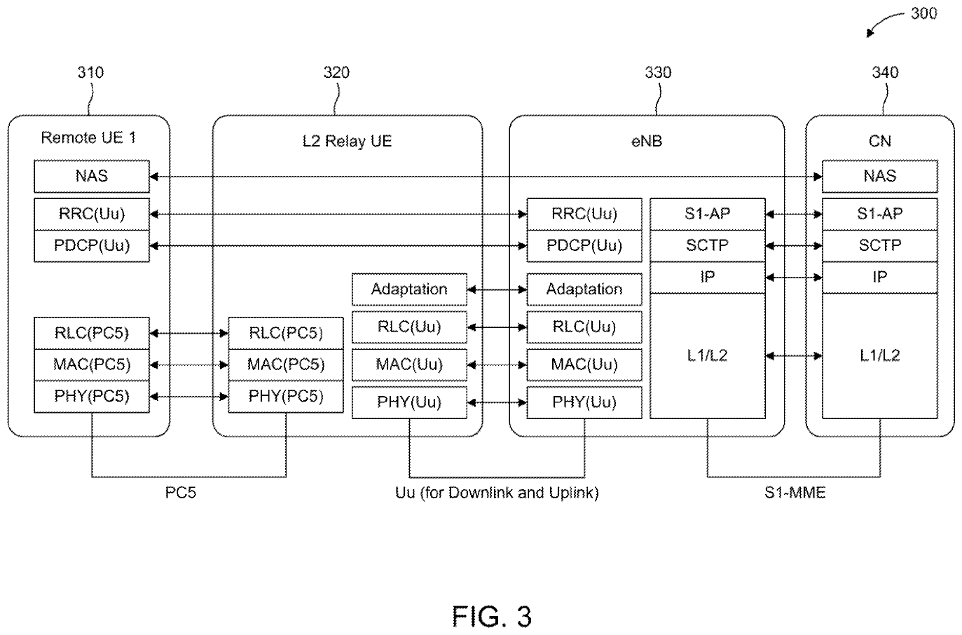

In an example related to WTRU to Network Relays for Wearables, WTRU to NW relays for commercial use cases tailored to wearables and IoT devices may be performed in RAN. Contrary to ProSe WTRU to NW relays which uses a L3 (IP layer) relaying approach, the WTRU to NW relays for wearables may be a L2 relay based on the protocol stacks shown below in FIG. 2 illustrating a user plane radio protocol stack for layer 2 evolved WTRU-to-Network relay (PC5) and FIG. 3 illustrating a control plane radio protocol stack for layer 2 evolved WTRU-to-Network relay (PC5).

FIG. 2 illustrates a user plane radio protocol stack 200 for layer 2 evolved WTRU-to-Network relay (PC5). Stack 200 includes a remote WTRU 210, a L2 relay WTRU 220, an eNB 230, and a CN 240.

Remote WTRU 210 may include resources to connect using an IP connection, PDCP (Uu) connection, and a PC5 connection. The PC5 resources may include RLC (PC5), MAC (PC5) and PHY (PC5). The IP connection may be communicatively coupled with an IP connection via CN 240. The PDCP (Uu) connection may be communicatively coupled to a PDCP (Uu) connection via eNB 230. The PC5 connection may be communicatively coupled to a PC5 connection at L2 relay WTRU 220 utilizing the resources such as RLC (PC5), MAC (PC5) and PHY (PC5).

L2 relay WTRU 220 may include resources to connect using a PC5 connection and Uu for downlink and uplink. The PC5 resources may include RLC (PC5), MAC (PC5) and PHY (PC5). The PC5 connection may be communicatively coupled to a PC5 connection at remote WTRU 210 utilizing the resources such as RLC (PC5), MAC (PC5) and PHY (PC5). The Uu connection may include resources RLC (Uu), MAC (Uu) and PHY (Uu). The Uu connection may be communicatively coupled to a Uu connection at eNB 230 utilizing the resources such as RLC (Uu), MAC (Uu) and PHY (Uu).

eNB 230 may include resources to connect using a PDCP (Uu) connection, Uu for downlink and uplink, and a S1-U/S5/S8 for remote WTRU 210. The PDCP (Uu) connection may be communicatively coupled to a PDCP (Uu) connection via remote WTRU 210. The Uu connection may include resources RLC (Uu), MAC (Uu) and PHY (Uu). The Uu connection may be communicatively coupled to a Uu connection at L2 relay WTRU 220 utilizing the resources such as RLC (Uu), MAC (Uu) and PHY (Uu). The S1 connection may be communicatively coupled to CN 240 via resources GTP-U, UDP/IP and L1/L2.

CN 240 may include resources to connect using IP connection, and a S1-U/S5/S8 for remote WTRU 210. The IP connection may be communicatively coupled with an IP connection via remote WTRU 210. The S1 connection may be communicatively coupled to eNB 230 via resources GTP-U, UDP/IP and L1/L2.

FIG. 3 illustrates a control plane radio protocol stack 300 for layer 2 evolved WTRU-to-Network relay (PC5) Stack 300 includes a remote WTRU 310, a L2 relay WTRU 20, an eNB 230, and a CN 240.

Remote WTRU 310 may include resources to connect using a NAS connection, Uu connection, and a PC5 connection. The Uu connection may include RRC (Uu) an PDCP (Uu) resources. The PC5 resources may include RLC (PC5), MAC (PC5) and PHY (PC5). The NAS connection may be communicatively coupled with an NAS connection via CN 340. The Uu connection may be communicatively coupled to a Uu connection via eNB 330 utilizing resources RRC (Uu) an PDCP (Uu). The PC5 connection may be communicatively coupled to a PC5 connection at L2 relay WTRU 220 utilizing the resources such as RLC (PC5), MAC (PC5) and PHY (PC5).

L2 relay WTRU 320 may include resources to connect using a PC5 connection and Uu for downlink and uplink. The PC5 resources may include RLC (PC5), MAC (PC5) and PHY (PC5). The PC5 connection may be communicatively coupled to a PC5 connection at remote WTRU 310 utilizing the resources such as RLC (PC5), MAC (PC5) and PHY (PC5). The Uu connection may include resources RLC (Uu), MAC (Uu) and PHY (Uu). The Uu connection may be communicatively coupled to a Uu connection at eNB 330 utilizing the resources such as RLC (Uu), MAC (Uu) and PHY (Uu).

eNB 330 may include resources to connect using a Uu connection, Uu for downlink and uplink, and a S1-MME. (Uu). The Uu connection may be communicatively coupled to a Uu connection via remote WTRU 310 utilizing resources RRC (Uu) an PDCP (Uu). The Uu connection may include resources RLC (Uu), MAC (Uu) and PHY (Uu). The Uu connection may be communicatively coupled to a Uu connection at L2 relay WTRU 320 utilizing the resources such as RLC (Uu), MAC (Uu) and PHY (Uu). The S1-MME connection may be communicatively coupled to CN 340 via resources S1-AP, SCTP, IP and L1/L2.

CN 340 may include resources to connect using NAS connection, and a S1-MME. The NAS connection may be communicatively coupled with an NAS connection via remote WTRU 310. The S1 connection may be communicatively coupled to eNB 330 via resources S1-AP, SCTP, IP and L1/L2.

Additional details regarding the various connection illustrated in FIGS. 2 and 3 as described below. For examples including connection establishment for unicast links in NR V2X, the relay solutions in previous solutions were based on a one to one communication link established at upper layers (ProSe layer) between two WTRUs (the remote WTRU and WTRU to NW relay). Such connections may be transparent to the AS layer and connection management signaling and procedures performed at the upper layers are carried by AS layer data channels. The AS layer is therefore unaware of such a one to one connection.

This has evolved to the AS layer supporting a unicast link between two WTRUs. Such unicast link is initiated by upper layers (as in the ProSe one-to-one connection). The AS layer may be informed of the presence of such unicast link, and any data that is transmitted in unicast fashion between the peer WTRUs. With such knowledge, the AS layer may support HARQ feedback, CQI feedback, and power control schemes which are specific to unicast. A unicast link at the AS layer may be supported via a PC5-RRC connection. The PC5-RRC connection may be defined where the PC5-RRC connection is a logical connection between a pair of a Source Layer-2 ID and a Destination Layer-2 ID in the AS. One PC5-RRC connection is corresponding to one PC5 unicast link. The PC5-RRC signaling, as specified herein, may be initiated after its corresponding PC5 unicast link establishment. The PC5-RRC connection and the corresponding sidelink SRBs and sidelink DRBs are released when the PC5 unicast link is released as indicated by upper layers.

For each PC5-RRC connection of unicast, one sidelink SRB is used to transmit the PC5-S messages before the PC5-S security has been established. One sidelink SRB is used to transmit the PC5-S messages to establish the PC5-S security. One sidelink SRB is used to transmit the PC5-S messages after the PC5-S security has been established, which is protected. One sidelink SRB is used to transmit the PC5-RRC signaling, which is protected and only sent after the PC5-S security has been established.”

PC5-RRC signaling includes a sidelink configuration message (RRCReconfigurationSidelink) where one WTRU configures the RX-related parameters of each SLRB in the peer WTRU. Such reconfiguration message may configure the parameters of each protocol in the L2 stack (SDAP, PDCP, etc.). The receiving WTRU may confirm or reject such configuration, depending on whether it may support the configuration suggested by the peer WTRU.

For system information for NR WTRU to NW Relays, a remote WTRU may receive system information from a relay WTRU when PC5-RRC connected to the relay WTRU. The mechanism is based on the following remote WTRU and relay WTRU behaviors. For an SI Request: the remote WTRU in IDLE/INACTIVE may send SI request to the relay WTRU using PC5-RRC message (of which the relay WTRU is aware of the requested SI), the relay WTRU, if it does not have the latest SI requested by the remote WTRU, may request/acquire the SI from the network using legacy mechanisms, the remote WTRU in CONNECTED may send dedicatedSIBRequest via the relay WTRU to the network. This Uu RRC message is sent transparently to the relay WTRU. The network may send the requested SIB via the relay WTRU, transparently to the relay. For SI Acquisition: parts of SIB1 (e.g., access control parameters) may be obtained by the remote WTRU before PC5-RRC connection establishment, other SI may be obtained after the remote WTRU establishes a PC5-RRC connection with the relay, the relay WTRU in sends SI to the remote WTRU following request by the remote WTRU, the relay WTRU in sends SI to the remote WTRU following update of any SI that was previously requested by the remote WTRU via an SI request, and upon reception of SI modification by a relay WTRU, the relay sends the updated SI to all remote WTRUs in IDLE/INACTIVE.

The following provides a summary of RRC States and Corresponding WTRU behavior. A WTRU may be characterized by its RRC state to be either RRC_CONNECTED, RRC_INACTIVE, and RRC_IDLE. The WTRU behavior associated with these states is as follows:

### RRC_IDLE:

PLMN selection;
Broadcast of system information;
Cell re-selection mobility;
Paging for mobile terminated data is initiated by 5GC;
DRX for CN paging configured by NAS.

### RRC_INACTIVE:

PLMN selection;
Broadcast of system information;
Cell re-selection mobility;
Paging is initiated by NG-RAN (RAN paging);
RAN-based notification area (RNA) is managed by NG-RAN;
DRX for RAN paging configured by NG-RAN;
5GC-NG-RAN connection (both C/U-planes) is established for WTRU;
The WTRU AS context is stored in NG-RAN and the WTRU;
NG-RAN knows the RNA which the WTRU belongs to.

### RRC_CONNECTED:

5GC-NG-RAN connection (both C/U-planes) is established for WTRU;
The WTRU AS context is stored in NG-RAN and the WTRU;
NG-RAN knows the cell which the WTRU belongs to;
Transfer of unicast data to/from the WTRU;
Network controlled mobility including measurements.

SL WTRU to NW relays may focus on the OOC remote WTRU. A remote WTRU may operate in multipath when in coverage (one path over direct Uu, and another path via the SL WTRU to NW relay). This allows for more flexible request and acquisition of system information by the remote WTRU. For example, the remote WTRU may request SI via the relay WTRU and receive it directly via Uu (given that UL transmissions are more expensive from power consumption, and SI delivery may rely on broadcast when delivery is performed by the network). It also distributes the SI requests over different paths, to avoid congestion of each path separately.

Inclusion of the multipath case, and allowing the path flexibility also introduces additional issues. For example, the relay WTRU needs to handle both remote WTRUs which support multipath and those which do not. To ensure diversity in the selection of path (and avoid that one path is congested with SI requests compared to the other), some specified rules for path selection may be needed. In essence, there may be cases where it is more efficient to request/receive SI over one path rather than another, however, these may also depend on the preference of the relay which needs to perform the forwarding. SI request/delivery mechanism may be dependent on the RRC state of the relay/remote WTRU. A new RRC state combination for multipath (i.e., the relay in IDLE/INACTIVE while remote WTRU in CONNECTED) may need to be handled for the multipath case. SI request may be different for RRC_IDLE/RRC_INACTIVE compared to RRC_CONNECTED, and such differences may need to be considered when the remote and relay WTRU are in different RRC states but requesting/receiving SI via the network Further, there may be a benefit, e.g., to avoid that SI is sent by the relay WTRU to the remote WTRU when the remote WTRU may also acquire it on Uu. Race conditions may be possible, for example, when a remote WTRU receives SI modification from one path and the actual SI from another, and such race conditions may be addressed to avoid unnecessary WTRU power consumption or unsynchronized SI at the remote WTRU.

The present system and method includes a relay WTRU that determines whether to forward SI to a remote WTRU following request by the remote WTRU based on the coverage/capability indicated by the remote WTRU and the RRC state of the relay WTRU. The relay WTRU receives capability information related to whether the remote WTRU supports multipath from a remote WTRU in PC5-RRC capability exchange, receives an SI request from a remote WTRU containing a coverage indication (IC/OOC), requests the corresponding SI from the network, and if the requesting remote WTRU supports multipath and indicates IC in the request and the relay WTRU is in RRC_IDLE/RRC_INACTIVE, the relay WTRU, upon receiving indication that the SI request was transmitted, sends an indication to the remote WTRU that the requested SI may be obtained directly on Uu, otherwise (Legacy remote WTRU, OOC remote WTRU, or relay WTRU in RRC_CONNECTED) and the relay WTRU obtains the requested SI and sends it to the remote WTRU (via PC5-RRC).

The present system and method, such as a possible corresponding remote WTRU behavior, includes the remote WTRU determines whether to request/receive SI from the network or relay based on Uu quality, SI request configuration (MSG1 or MSG3-based), and indication from the relay following SI request. The remote WTRU configured in multipath receives a Uu quality threshold for sending SI request via Uu directly, receives a Uu quality threshold for receiving SI via Uu, receives an SI request config from SIB1 indicating MSG1-based or MSG3-based SI request, and if the Uu quality is above threshold for sending the SI request and the WTRU is configured for MSG1-based SI request, sends the SI request via Uu and receives the requested SI via Uu, otherwise computes an IC/OOC indication based on whether the measured Uu quality is above/below the SI receiving via Uu threshold, sends the SI request to the relay WTRU, including a computed IC/OOC indication, and if the relay WTRU indicates to receive the SI via Uu, receives the requested SI via Uu, otherwise, receives the requested SI via the relay WTRU.

The present system and method, such as a new dedicated SIBRequest usable by a relay, includes the relay, following reception of a new SIB, may indicate to the network whether a SIB may be provided in dedicated signaling or broadcast. The relay WTRU receives a PC5-RRC message from the remote WTRU enabling/disabling SI forwarding via SL, receives a SI requests from a remote WTRU, upon reception by the relay WTRU of a new SIB or an SI update notification for an updated SI required by at least one remote WTRU. For a relay WTRU in RRC_CONNECTED, if the relay is configured on a BWP without CSS and at least one relay WTRU has SIB forwarding disabled via SL, sends a dedicatedSIBRequest indicating SIB may be broadcast, otherwise sends legacy dedicatedSIBRequest. For a relay WTRU in RRC_IDLE/RRC_INACTIVE, sends SI request to the network, if at least one relay WTRU has SIB forwarding enabled via SL, forwards the SI to the remote WTRU.

The system and methods described herein provide for system information request and reception for multipath WTRU to NW Relay. A remote WTRU in multipath refers to a remote WTRU which is served by a network node (gNB) or by another WTRU (in the case of V2X), where the remote WTRU may send receive data to its destination via multiple paths. One such path may be a direct Uu path (for the case where it is served by a gNB), if the remote WTRU is in coverage. Another such path may be via a SL relay. For simplicity, the description generally focuses on a remote WTRU is served by a gNB via a single Uu path and a single SL relay path. The descriptions also apply with obvious extensions to additional cases, such as: multiple (more than 2) paths of either direct and/or relayed, multiple paths of only direct, multiple paths of only relayed, and paths where the relayed path is a multihop path, for example.

Furthermore, although this disclosure deals with the request and delivery of system information in the case of multipath, the disclosure may also apply equally well to other control information delivery, such as RRC messages, paging messages, etc.

Path Determination of SI Request/SI Reception may occur where the remote WTRU in multipath determines which path to send the SI request or receive SI, the remote WTRU in multipath determines which path to receive SI, the remote WTRU indicates to relay WTRU/gNB the requested or desired path, relay WTRU determines whether or not to send SI to the remote WTRU, relay WTRU performs SI request without SI acquisition, relay WTRU indicates a preference for SI transmission by the network, relay WTRU is configured with forwarding behavior for SI, and the contents of the SI request from the remote WTRU to relay WTRU.

For the remote WTRU in multipath determines which path to send SI Request or receive SI, a remote WTRU in coverage that requires SI which is not being broadcast by the network may request such SI. A remote WTRU may be in multipath and may send an SI request to receive SI information. Such a remote WTRU may decide which path(s) to use to send the SI request and/or receive SI based on one or a combination of the following factors. The RRC state of the remote and/or relay WTRU may be used for the decision.

The remote WTRU may determine the SI request path based on the RRC state of the remote WTRU. For example, a remote WTRU in RRC_CONNECTED may always request SI via the relay, while a remote WTRU in RRC_IDLE/RRC_INACTIVE may always request SI via Uu. Alternatively, a remote WTRU in RRC_CONNECTED may request SI via either path, based on solutions herein, while a remote WTRU in RRC_IDLE/INACTIVE may request SI only via Uu.

The remote WTRU may determine the SI request path based on the RRC state of the relay WTRU. For example, when the relay WTRU is in RRC_CONNECTED, the remote WTRU may send SI request via the relay/direct, whereas when the relay WTRU is in RRC_IDLE/RRC_INACTIVE, the remote WTRU may send SI request via direct/relay path. The remote WTRU may determine the RRC state of the relay WTRU based on explicit messaging from the relay (e.g., in discovery message, or a PC5-RRC message transmitted by the relay). Alternatively, the remote WTRU may determine the RRC state of the relay WTRU implicitly based on other information/indication transmitted by the relay WTRU, as described herein. For example, the RRC state of the relay WTRU may be learned implicitly by the remote WTRU. For example, the relay WTRU may send a PC5-RRC message upon a change of state in the relay WTRU, that would cause the remote WTRU to determine its behavior for SI request (enable/disable SI request via the relay WTRU).

The remote WTRU may determine the SI request path based on state combination of remote WTRU and relay WTRU RRC state. For example, for the state combination of remote WTRU in RRC_CONNECTED, and relay WTRU in RRC_IDLE/RRC_INACTIVE, the remote WTRU may send the SI request via the direct path only (to avoid the relay WTRU from initiating an RRC connection for sending the dedicatedSIBRequest). For other state combinations, the remote WTRU may send the SI request via any path, or may rely on other rules herein to select the path.

The Uu measurements of cell quality may be used in the decision. The remote WTRU may determine the SI request path based on the measured cell quality on Uu. For example, the remote WTRU may send SI request via Uu if the measured Uu RSRP is above a threshold, otherwise, it may send SI request via SL. For example, the remote WTRU may send SI request via Uu if it is in coverage, and may send SI request via the relay if it is out of coverage.

The SL measurements may be used in the decision. The remote WTRU may determine the SI request path based on the measured SL quality. For example, the remote WTRU may send SI request via SL if the measured SL RSRP is above a threshold, otherwise, it may send SI request via SL. For example, the remote WTRU may send SI request via Uu if the measured CBR is above a threshold. For example, a remote WTRU may be connected in multipath via multiple SL relays and may send SI request to the SL relay corresponding to the best SL measurements (e.g. higher SL RSRP, possibly by a threshold), or may send SI request via any of the SL relays which has SL RSRP above a threshold. For example, a remote WTRU may send SI request to multiple WTRUs if the RSRP of the multiple SLs are all below a threshold. For example, a remote WTRU may send SI request via multiple SL relays if the CBR is above a threshold.

The SI request configuration may be used in the decision. The remote WTRU may determine the SI request path based on the legacy SI request configuration from the network. Specifically, if the remote WTRU is configured (via SIB) to perform MSG1-based SI request, the remote WTRU may use the Uu path, otherwise, the remote WTRU may use the SL path, or may choose the path based on other conditions described herein.

A condition of whether the required SI is currently being broadcast or not may be used in the decision. For example, the remote WTRU may receive SI via Uu if the required SI is currently being broadcast (and the remote WTRU does not need to perform an SI request). If the required SI is not currently being broadcast, the remote WTRU may request and/or receive SI via SL, or may use other conditions herein to decide whether to receive via Uu or SL.

A new NW configuration may be used in the decision. The remote WTRU may be configured (e.g. in SIB or dedicated signaling) select or prioritize one path over another path. Such configuration may be explicit, or may be in the form of a rule associated with another other factor. For example, the network may configure a range of Uu RSRPs for which SI request may take place via SL/Uu. For example, the WTRU may receive an explicit configuration of whether SI request may be performed over Uu or SL, possibly applicable to a subset of the conditions herein (e.g. certain RRC state combinations).

The remote WTRU may receive a configuration of SRB1 and may determine the path for SI request based on SRB1 configuration. Specifically, the remote WTRU may follow the SRB1 configuration for determining the path to send dedicatedSIBRequest. If SRB1 is configured on both paths, the remote WTRU may determine the path to use based on other conditions herein

The cell ID/area ID of the relay WTRU's connected cell may be used in the decision. The remote WTRU may determine the SI request path based on the identification of the relay WTRUs cell (the cell to which the relay WTRU is connected or camped), possibly in connection with the cell to which the remote WTRU is in coverage. For example, the remote WTRU may request SI via Uu if the cells are different, or if the cells belong to different area IDs.

The remote WTRU may determine the SI request path based on the cell to which the WTRU is camped or connected. Specifically, the remote WTRU may be in multipath with Uu with a first cell, and a relay connected to second cell. A remote WTRU may be camped or connected to one of these two cells, while using both paths for data transmission. The remote WTRU may determine the path to request/receive SI on based as the path associated with the camped/associated cell. Specifically, the remote WTRU may change the path if it performs a mobility procedure from the first cell to the second cell.

For example, the relay WTRU may request/receive SI from any of the paths (possibly using other conditions herein) as long as the first cell and the second cell are the same (i.e., have the same cell ID), otherwise, it may only use a single path.

For example, the remote WTRU may acquire SI from either path in case the first and second cells are different, as long as the area ID associated with the SI is the same.

For example, a remote WTRU may request SI only from one path (e.g., the path associated with the PCell) when the cells on both paths of the multipath are different. On the other hand, if the cells associated with the two paths are the same, the remote WTRU may request SI from either/both paths, possibly by selecting the path based on other conditions herein, possibly requesting SI based on SRB1 configuration (e.g., send dedicatedSIBRequest to the path(s) in which SRB1 is configured, send dedicatedSIBRequest to the primary path in case split SRB1 is configured, etc.).

For example, a remote WTRU may enable SI forwarding by the relay WTRU (as per mechanism described herein—i.e., sending PC5-RRC message) when the cell of the relay WTRU is the same as the cell of the remote WTRU, possibly with other conditions (e.g., only when the remote WTRU is in IDLE/INACTIVE). Alternatively, or additionally, the remote WTRU may disable SI forwarding by the relay WTRU (as per mechanism described herein—i.e., sending PC5-RRC message) when the cell of the relay WTRU is different than the cell of the remote WTRU. For example, the remote WTRU may change from enabled/disabled based on the above conditions following HO of the direct path, or following reception of an indication from the relay WTRU of a HO/cell change.

Previous requests and/or failure of such a request may be used in the decision. The remote WTRU may use results of previous SI requests to determine the path of a current SI request. For example, if a previous SI request on Uu was not successful, the remote WTRU may request SI via both paths or via SL only. A remote WTRU may determine failure of a request on one path based on any of the following: expiration of a time period: For example, following SI request on Uu/SL, if the remote WTRU is unable to acquire the requested SI, the remote WTRU may attempt SI request on the other path; and response to SI request: For example, following SI request on SL, the remote WTRU may receive a response from the relay WTRU indicating that the remote WTRU may attempt SI request via Uu instead.

SI being requested may be used in the decision. The remote WTRU may determine the path to select for requested SI based on the type of SI, or the specific SIB being requested. For example, one SI may only be allowed to be requested via the direct path. For example, the remote WTRU may request positioning SI only from Uu, but may request other SI from either path. For example, the remote WTRU may always receive SI via Uu, but may use another condition to determine whether to request/receive another SI via SL or via Uu. For example, the SIs requested/received via the relay may correspond to SIs which are also of interest to the relay WTRU. Specifically, the remote WTRU may learn the SIs which are of interest to the relay WTRU (either specifically for the relay WTRU, or for some other remote WTRU attached to that relay) through PC5-RRC messaging. The remote WTRU may then request/receive only the SIs of interest to the relay WTRU.

Frequency and/or nature of the carrier on Uu and/or SL maybe used in the decision. The remote WTRU may determine the path based on the type of carrier, or the frequency of the carrier associated with Uu or SL. For example, if one of the carriers (Uu or SL) is unlicensed, the remote WTRU may select the licensed carrier (e.g., to avoid an LBT operation). For example, if one of the carriers is FR2, the remote WTRU may use the other carrier to select SI.

Information/indication from the relay WTRU may be used in the decision. The remote WTRU may determine the path based on information/indication received from the relay WTRU. For example, the remote WTRU may receive a message from the relay WTRU enabling/disabling SI request via the relayed path. If the remote WTRU is in coverage and SI request is disabled via the relayed path, the remote WTRU may request SI via Uu only. For example, the remote WTRU may receive a time period over which SI request via the relayed path is not allowed. For example, the remote WTRU may be allowed to perform SI request via the relayed path as long as it has received some SI request configuration and/or SI request capability (e.g., in PC5-RRC) from the relay WTRU. The methodology the relay WTRU determines/uses to send such indication is further described herein.

A BWP configuration on Uu at the remote WTRU in RRC_CONNECTED may be used in the decision. The remote WTRU may determine the path for SI request/SI reception based on whether the BWP of the remote WTRU is configured with the common search space or not. Specifically, of the remote WTRU has a BWP configured with the common search space, the remote WTRU may request/receive SI over the Uu link and may disable any SI forwarding by the relay WTRU. If the remote WTRU has a BWP on Uu configured without the common search space, the remote WTRU may request/receive SI over the indirect link and may consequently enable SI forwarding by the relay WTRU (by sending a list of requested SI to the relay WTRU). Such behavior may further be necessary when the remote WTRU knows the relay WTRU to be in RRC_IDLE/RRC_INACTIVE. On the other hand, when the remote WTRU knows the relay WTRU to be in RRC_CONNECTED, the remote WTRU may send SI request using dedicatedSIBRequest to the network rather than by requesting the SI in PC5-RRC to the relay WTRU.

SL DRX and/or Uu DRX configuration/state of the relay and/or remote WTRU may be used in the decision. The remote WTRU may determine the path based on the Uu and/or SL DRX configuration or state. For example, if SI request occurs when the relay WTRU is in SL DRX inactive time, the remote WTRU may send the SI request via Uu. For example, if the SI request occurs when the remote WTRU is in Uu DRX, the remote WTRU may send the SI request via SL.

Number of hops/paths may be used in the decision. For example, the remote WTRU may determine to send SI request via direct path if the number of hops on the SL relayed path is above a threshold

Availability of resources may be used in the decision. For example, the remote WTRU may use the path which has resources available (possibly the path having the first resource available).

Bearer configuration may be used in the decision. For example, the remote WTRU may be configured with a bearer that allows/prioritizes request for SI via SL/Uu. For example, the remote WTRU may be configured with a bearer configuration such that the remote WTRU may send SI request to both paths

Last active link for data transmission may be used in the decision. The remote WTRU may determine the path based on the last active path for communication. For example, the remote WTRU may be configured with an active path or primary path while in multipath (e.g. the primary path may be associated with a particular bearer, or may be WTRU specific). For example, the remote WTRU may transition to RRC_INACTIVE, and may determine the path for SI request based on the last active/primary path.

Whether the relay WTRU supports/accepts SI forwarding/delivery may be used in the decision. For example, a relay WTRU may support relaying of user plane data, but not of control plane data. For example, a relay WTRU may support a multipath connection whereby the primary path (or concept similar to the primary path in dual connectivity) may be through another path (i.e., the direct Uu, or another relayed path). A relay WTRU may inform the remote WTRU of the support of such SI forwarding support via discovery or PC5-RRC message. The remote WTRU, based on reception of this information from the relay WTRU, may decide to request/receive SI over the Uu path if the relay does not support SI forwarding. Otherwise, the remote WTRU may use either path (or decide the path based on other criteria herein).

Following multipath configuration/deconfiguration, and whether multipath is configured by adding the direct or indirect path may be used in the decision. For example, a remote WTRU connected via a relay may be configured in multipath by adding a direct path. Following such addition, the remote WTRU may change from receiving SI via the relay WTRU to receiving SI via Uu. On the other hand, a remote WTRU may be configured in multipath by adding an indirect path. Following such addition, the remote WTRU may maintain reception of SI via the Uu path. Specifically, if configured in multipath and in RRC_CONNECTED, the remote WTRU may request/receive SI always via Uu. If not configured in multipath while in RRC_CONNECTED, the remote WTRU may use the specific path that provides the connection to request/receive SI

A remote WTRU may disable SI request via the relay WTRU if SI request via the relay WTRU is enabled, and the remote WTRU decides to request/receive SI via Uu link instead. Specifically, a condition may change which makes the remote WTRU request/receive SI via Uu when it was previously requesting/receiving via SL. Upon such change, the remote WTRU may transmit an PC5-RRC message to disable reception at the relay WTRU of SI on behalf of the remote WTRU. The opposite is also applicable. Specifically, if a condition changes which makes the remote WTRU request/receive the SI via the relay WTRU, the remote WTRU may transmit a PC5-RRC message to indicate all SI's which the remote WTRU is interested in receiving from the relay WTRU. A remote WTRU may further indicate that the request (via the PC5-RRC message) is just for the purposes of re-enabling SI change forwarding and not for actually receiving the SI. Specifically, the relay WTRU, upon receiving such indication, may include the list of SIs in the RRC message as the SIs to be forwarded upon change, but may not immediately forward the said SI to the remote WTRU. When such indication is not included, the relay WTRU may immediately forward the said SI.

The relay WTRU may indicate preference/disables SI Request (via the relay) for a remote WTRU. Related to the options, described above, for the remote WTRU, a relay WTRU may inform the remote WTRU that SI requests may be performed via Uu (or a different path) rather than via the said relay itself. Alternatively, the relay WTRU may indicate to the remote WTRU that the SI request to be performed via another path (e.g., Uu). The relay WTRU may make such determination based on one or a combination of the following.

The determination may be based on the Uu RSRP at the relay WTRU: For example, if the Uu RSRP measured by the relay WTRU is below a threshold, the relay WTRU may inform the remote WTRU that remote WTRU may use the Uu path.

The determination may be based on the BWP configuration of the relay WTRU in RRC_CONNECTED. For example, if the relay WTRU is in RRC_CONNECTED and configured with a bandwidth part without the common search space, the relay WTRU may indicate to the remote WTRU to request/receive SI via the Uu link.

The determination may be based on the RRC state of the relay WTRU. As described herein, the relay WTRU may disable to send preference for SI request via the relayed path based on the relay WTRU's RRC state.

The determination may be based on the whether the SI is being broadcast by the cell or not. For example, if the SI is not being broadcast at the cell, the relay WTRU may indicate to the remote WTRU that SI may be requested via Uu.

The determination may be based on the NW configuration. For example, the relay WTRU may be configured by the NW as to whether to inform the remote WTRU to disable SI requests via the relay or not.

The determination may be based on the SI request configuration. For example, if the relay WTRU is configured with MSG1 based SI request vs MSG3 based SI request.

The determination may be based on the load at the relay WTRU. For example, the relay WTRU may disable SI request by a remote WTRU to the relay based on relay load, which may be measured in terms of SL traffic, relay traffic, number of remote WTRUs connected to the relay, etc.

The determination may be based on the DRX state of the relay WTRU. For example, the relay WTRU may send a period of time (e.g., corresponding to the DRX off period at the relay WTRU) in which the remote WTRU may perform SI request directly via Uu.

The remote WTRU, following the indication by the relay WTRU, may directly determining whether to request SI via the relay WTRU or via the network. Alternatively, the remote WTRU may use other conditions herein. For example, if the relay WTRU recommends SI is sent via Uu, the remote WTRU may determine the path of SI request using one condition. If the relay WTRU does not recommend this, the remote WTRU may determine the path of SI request via another condition.

Combinations of the criteria are also possible and may be used in the decision. A combination may be selecting a first path if a first condition and/or a second condition is met, and selecting a second path otherwise. A combination may include selecting a first path under a first condition, while selecting either a first path or a second path based on a combination of other conditions. A combination may include selecting a first or a second path based on a combination (e.g., comparison) of two different criteria (e.g., SL quality and Uu quality). A combination may include using a first condition to determine whether to use a second condition or to use a third condition in determining whether to use Uu or SL. Other examples of combinations are also contemplated and are not precluded.

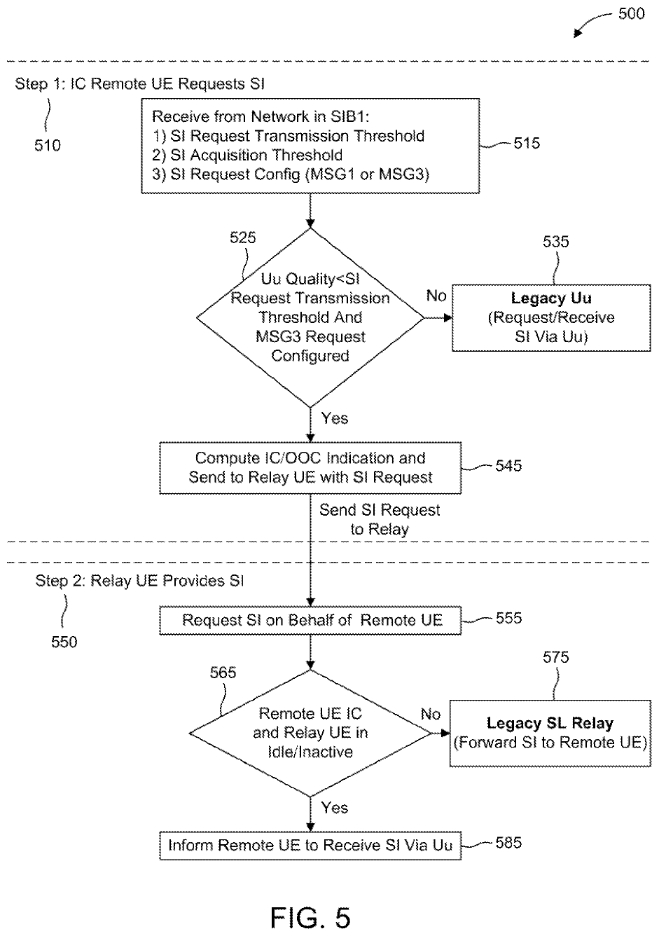

Without loss of generality, the solutions herein for determining whether the remote WTRU requests/receives SI on Uu and/or SL may be extended to the reception/transmission of any control or data exchange with the network, such as paging. In one example, (partially illustrated in FIG. 5), the remote WTRU may receive an SI request transmission threshold from the network. The remote WTRU may further receive SI request configuration (i.e., MSG1 configuration) in SIB1. The remote WTRU may measure the Uu quality.

If the Uu quality is below a threshold, and the WTRU is configured to use MSG3 based SI request via Uu, the remote WTRU may request SI via the SL relay. Otherwise, the WTRU may request SI via the Uu path.

In an example, the remote WTRU may determine the path for SI request and/or SI acquisition based on a combination of RRC state of the remote WTRU, support of SI by the relay WTRU, and other condition(s) described herein. For example, the remote WTRU may receive indication from the relay WTRU (e.g., in discovery or PC5-RRC message) that the relay WTRU does not support SI acquisition on behalf of the remote WTRU. However, a remote WTRU may still rely on transparent forwarding of that SI via the relay WTRU. Specifically, under the condition where the relay WTRU indicates to the remote WTRU that the remote WTRU does not support SI request/acquisition on behalf of the relay:

If the remote WTRU is in RRC_IDLE/RRC_INACTIVE, the remote WTRU requests SI and acquires SI via the Uu link directly. The remote WTRU may monitor SIB1 on Uu to determine if any SI has changed, and acquire the changed SI.

If the remote WTRU is in RRC_CONNECTED, the remote WTRU may request SI via either path (Uu directly, or relay path) and may acquire the SI via any path (possibly unrelated to the requesting path). For example, the remote WTRU may determine the path for SI request based on NW configuration for the SRB path or SI request path. For example, the remote WTRU may determine the path for SI request based on the Uu and/or SL RSRP and/or SL CBR.

Under the condition that the relay WTRU indicates to the remote WTRU that the remote WTRU supports SI request/acquisition, path selection for SI request may be independent of RRC state, and may depend on other factors herein. Alternatively, the WTRU may use a first condition and/or decision factor(s) for path selection in RRC_CONNECTED, and use a second condition and/or decision factor(s) for path selection in RRC_IDLE/RRC_INACTIVE.

The remote WTRU may determine the method for SI request to the relay based on RRC state of the relay. A remote WTRU in RRC_CONNECTED may determine the method/RRC protocol stack/RRC message for SI request (e.g., using SI request to the relay WTRU via PC5-RRC or using dedicatedSIBRequest transmitted via the relay but to the network). Specifically, when the relay WTRU is in RRC_CONNECTED, the remote WTRU may request SI via the relay WTRU using dedicatedSIBRequest (Uu RRC message). Alternatively, when the relay WTRU is in RRC_IDLE/RRC_INACTIVE, the remote WTRU may request SI via PC5-RRC message. The remote WTRU may learn of the RRC state of the relay WTRU: explicitly from the relay WTRU (e.g., in a PC5-RRC message or a MAC CE); explicitly from the network (e.g., in a Uu RRC reconfiguration, or similar Uu RRC message); implicitly based on other configuration, for example, the remote WTRU may be configured with the behavior for transmitting SI request to the relay WTRU based on an indication (e.g., flag) received from the network in an RRC message.

The remote WTRU in multipath may determine whether to duplicate SI request. In one solution, a remote WTRU in multipath may determine whether to transmit SI request using duplication. Such a determination may be based on one or a combination of the following criteria.

The RRC state of the remote WTRU may be used. For example, the remote WTRU may determine whether to duplicate SI request using different rules depending on the RRC state of the remote WTRU. For example, the remote WTRU may be allowed to duplicate SI request only when in RRC_CONNECTED.

Whether the cell ID of the paths is the same or not may be used.

Uu and/or SL RSRP may be used. For example, the remote WTRU may duplicate SI if either of the Uu RSRP is below a first threshold or the SL RSRP is below a second threshold. For example, the remote WTRU may duplicate SI if the RSRP on the link in which the remote WTRU decides to send SI request (based on conditions herein) is below a threshold.

For example, a remote WTRU may duplicate an SI request while in RRC_CONNECTED based on the SRB1 configuration (i.e., if configured with split/duplicate SRB1) without checking for RSRP and/or cell ID. On the other hand, if the remote WTRU is in RRC_IDLE/RRC_INACTIVE, the remote WTRU may duplicate SI request (i.e., send SI request on both links for the same SI) only when the cell ID is the same on both paths and based on conditions on the Uu and/or SL RSRP, as per above.

For example, a remote WTRU may duplicate an SI request while in RRC_IDLE/RRC_INACTIVE only when the cells associated with the direct and indirect link are the same.

The relay WTRU may release the Requested SI List associated with a remote WTRU following cell change. In one solution, a relay WTRU may release the requested SI list received from a remote WTRU (i.e., in PC5-RRC) following a cell change at the relay WTRU, such as a HO at the relay WTRU, or a reselection by the relay WTRU. Such a release may be required because the remote WTRU may no longer be able to receive SI from the relay WTRU given that the relay WTRU may move from the same cell as the remote WTRU (where SI may be forwarded) to a different cell (where the SI cannot be forwarded). Specifically, following the cell change at the relay WTRU, the relay WTRU may not send any updated SI to the remote WTRU based on the requested SI list.

For the example with the remote WTRU in multipath determining which path to receive SI on, a remote WTRU may decide/determine the path on which to receive SI while in multipath. The conditions for determining whether to receive SI on Uu and/or SL may be identical to the conditions described herein for determining whether to send SI request to Uu or SL, and are not repeated here for brevity. In addition, determining whether to receive SI from SL or Uu may have impacts on the WTRU's Uu/SL monitoring behavior. For example, a remote WTRU that decides to receive SI on Uu may be expected to monitor Uu PDCCH, possible for a period of time. A remote WTRU which decides to receive SI via SL may stop monitoring Uu PDCCH for SI updates or SI (e.g. perform Uu DRX during the SI broadcast schedule).

In one example, a remote WTRU may determine the SI request path based on a first condition, and determine the path to receive the requested SI based on a second condition. Specifically, the remote WTRU may request SI and receive SI on the same or different paths (based on independent decision). For example (illustrated in part in FIG. 5), the remote WTRU may be configured with a first Uu threshold for SI request, and a second Uu threshold for SI response. The remote WTRU may determine the path to request the SI based on comparison of the Uu RSRP with a first threshold. In addition, the remote WTRU may determine the path to receive the SI based and/or may determine whether to enable/disable receiving SI from the relay WTRU based on comparison of the Uu RSRP with a second threshold, possibly in combination with another conditions (e.g. indication from the remote WTRU).

In another example, the remote WTRU may determine the path to receive the SI on based on the path used to request the SI. Specifically, the paths may be assumed to be always the same.

In another example, the remote WTRU may determine the path to receive the SI on based on whether the interested SI is currently being broadcast by the network or not. Specifically, the remote WTRU may determine from SIB1 whether an SI is being broadcast or not. If an SI is being broadcast, the remote WTRU may receive it via Uu. If it is not being broadcast, the remote WTRU may request it via the SL relay path and also receive it via SL.

The decision for the path for requesting/receiving SI may be specific to the SI itself. Specifically, different rules/conditions may be defined based on the above that are specific to the SI or SIB. For example, the preference or disabling of SI request by the relay WTRU sent to the remote WTRU may be signaled per SI or SIB.

For an example where the remote WTRU indicates to relay WTRU/gNB the requested/desired path, a remote WTRU may indicate to the relay WTRU the requested/desired path for SI reception and/or whether SI may be forwarded via SL or not by the relay WTRU. Specifically, the remote WTRU may determine a path for SI reception based on conditions herein. Following such a determination, the remote WTRU may indicate to the relay WTRU the selected path. Alternatively, if the remote WTRU decides the Uu path, it may request the relay WTRU not to provide the SI on SL, and vice versa. Such an indication may come in a PC5-RRC message (to the relay WTRU), or may come in a Uu RRC message (if the indication is to the gNB). Such an indication may be sent along with the SI request. Such an indication may be in the form of an enable/disable signal. Specifically, such an indication may turn on or turn off SI forwarding by the relay WTRU on SL. If SI forwarding was last turned on, the remote WTRU may receive SI directly from the relay WTRU. If SI forwarding was turned off, the remote WTRU may receive SI from the network on Uu.

The remote WTRU may determine whether/what indication to send to the relay WTRU based on a combination of conditions described herein. For example, the remote WTRU may turn on SI forwarding (by sending an SI forwarding enable/request) by the relay WTRU when the remote WTRU is OOC and in either RRC_IDLE/RRC_INACTIVE, or when the remote WTRU is in coverage and is in either RRC_IDLE/, otherwise (remote WTRU in RRC_CONNECTED, or remote WTRU in coverage), the remote WTRU may turn off SI forwarding (by sending an SI forwarding disable). For example, the relay WTRU may turn on SI forwarding if the Uu RSRP is below a threshold (even if the remote WTRU is in coverage).

A relay WTRU, upon request of a desired path for SI reception, may accept or reject such request. Specifically, the relay WTRU may send an accept, or may simply send the SI. For example, the relay WTRU may send a reject when it decides to send the SI via a different path. The relay WTRU may make such determination based on conditions (described further herein) for deciding whether the relay WTRU may forward the SI to the remote WTRU, or let the network send the SI (i.e. and possibly not send any information to the remote WTRU).

Such an example may be extended to a request by the remote WTRU to the network. Specifically, a remote WTRU may indicate to the network the desired path to receive the SI (Uu or via the SL relay). Specifically, the remote WTRU may include a field in the dedicatedSIBRequest indicating whether the SI may be sent via Uu or via the relayed path. Alternatively, the remote WTRU may be configured with a dedicated RACH resource, a dedicated resource timing, or a request type (MSG1/MSG3) which implicitly indicates the desired path for SI reception.

In an example where the relay WTRU determines whether or not to send SI to the remote WTRU, the relay WTRU may determine whether to send SI to a remote WTRU. Such decision may be made following SI request by the said remote WTRU. Such decision may be made following determination, by the relay WTRU, that SI has been changed (e.g. following reception of SI modification, or following determination of a change in value tag of an SI). If a relay WTRU determines to send the SI, it may send the SI at some time following SI request, or SI update. If a relay WTRU may determine to not send the SI, it may abstain from transmitting SI. Alternatively, it may send an indication to the remote WTRU that SI is not transmitted. Such indication may be used by the remote WTRU to monitor SI on Uu.

A relay WTRU, in addition to deciding whether or not to send SI to the remote WTRU, may still perform an SI request to the network. Specifically, although a relay WTRU decides to not forward the SI, it may still perform an SI request to the network (in order to allow the remote WTRU to acquire the SI from the network).

The relay WTRU may determine whether or not to send/forward SI to the remote WTRU and/or whether an SI request is still required based on one or a combination of the following RRC state of the remote and/or relay WTRU, SL measurements, SL link state, SI being requested, information/indication from the remote WTRU, whether the relay WTRU has the required SI at the relay or whether it must request/acquire it, and whether the relay WTRU requires the SI for itself or not.

For the RRC state of the remote and/or relay WTRU, the relay may determine whether to send the SI to the remote WTRU based on the RRC state of the remote WTRU and/or the relay WTRU. For example, upon SI update determined at the relay WTRU, the relay WTRU may send the SI to the remote WTRU as long as the remote WTRU is not in RRC_CONNECTED. When the remote WTRU is in RRC_CONNECTED, the relay WTRU may assume the SI may be obtained by the remote WTRU via Uu. The relay WTRU may implicitly know the RRC state of the remote WTRU based on indication from the remote WTRU, as described further herein.

The relay WTRU may determine whether to send updated SI to the remote WTRU based on its own RRC state. Specifically, if the relay WTRU is in RRC_CONNECTED and possibly of the relay WTRU is configured with a common search space, the relay WTRU may forward any updated SI to the remote WTRU. Otherwise, the relay WTRU may not forward any updated SI to the remote WTRU, even when such updated SI is part of the list of interested SI provided by the remote WTRU to the relay WTRU

For SL measurements, the relay WTRU may determine whether to send SI to the remote WTRU based on SL measurements of SL CBR, SL RSRP, etc. For example, the relay WTRU may be configured with a SL CBR threshold for forwarding SI following determination of an SL update. The relay WTRU may forward SI as long as the measured SL CBR is above a threshold, otherwise, the SI may not be forwarded.

For SL link state, for example, the relay WTRU may not forward SI, potentially following determination of an SI update, if it has determined that SL RLF has occurred (e.g. by its own determination of SL RLF, or by an indication from the remote WTRU of a SL RLF).

For SI being requested, for example, the relay WTRU may forward one specific SI if that SI is updated, but may not forward another SI if it is updated. For example, the relay WTRU may forward all SIs except the positioning SI. For example, the relay WTRU may not forward SIB1 upon SIB1 update, but may forward other SIs upon update of those SI. The relay WTRU may determine whether a specific SI gets forwarded or not: based on specification, based on configuration from the network or from upper layers, and based on indication/request from the remote WTRU.

For information/indication from the remote WTRU, for example, the relay WTRU may send SI if SI forwarding has been request/turned on by the remote WTRU (e.g. in PC5-RRC). Such indication may be a separate message, or may come as part of the SI request itself.

For whether the relay WTRU has the required SI at the relay or whether it must request/acquire it, for example, the relay WTRU may send SI to the remote WTRU if it already has the SI available, while it may assume/indicate the remote WTRU to acquire the SI if the relay WTRU would need to acquire and/or request the SI.

For whether the relay WTRU requires the SI for itself or not, for example, the relay WTRU may decide to send SI to the remote WTRU (following acquisition) if the relay WTRU also requires the SI, while it may assume/indicate the remote WTRU to acquire the SI if the relay WTRU does not require the SI.

A remote WTRU, upon reception of an indication that the relay WTRU does not request/receive SI for the remote WTRU, may initiate request/reception of SI via Uu.

Without loss of generality, the same conditions for determining whether to enable/disable SI request to the relay (determined at the relay) may be used for deciding whether the relay WTRU forwards the SI or not.

In the example where the relay WTRU may perform SI request without SI acquisition, a relay WTRU attached to a remote WTRU, where the remote WTRU has indicated to the relay WTRU that the remote WTRU is able to receive SI directly from Uu, may perform SI request without subsequent SI acquisition in some conditions. For example, the relay WTRU may perform SI request without subsequent SI acquisition if one or a combination of the following conditions holds including the relay WTRU determines that an SI has changed for an SI that is required by a remote WTRU, or receives a request for an SI from a remote WTRU, the relay WTRU does not require the SI for its own operation, the relay WTRU determines that the requested or modified SI is currently not being broadcasted by the network, and the relay WTRU determines that it will/may not forward the SI to the remote WTRU and rely on the remote WTRU to acquire the SI directly from Uu.

The relay WTRU may further inform the remote WTRU of such decision. For example, after an SI request by the remote WTRU to the relay WTRU, the relay WTRU may respond to the remote WTRU indicating that the SI may be acquired by the remote WTRU on Uu.

For the example where the relay WTRU may indicate preference for SI transmission by the network, a relay WTRU may indicate (e.g. in a dedicatedSIBRequest procedure), whether the network may provide the requests SIB(s) using dedicated RRC signaling to the relay WTRU, and/or may broadcast them. A relay WTRU may determine whether to request the network to broadcast SI based on the relay WTRU's on CSS configuration and knowledge/decision of the remote WTRU's SI reception path (Uu or SL) as described herein. For example, the relay WTRU may determine that the remote WTRU receives SI directly from Uu (based on mechanisms described herein). Following an event which requires the remote WTRU to acquire SI (e.g. SI update for an SI that is required by the remote WTRU, or SI request by the remote WTRU), if the relay WTRU is in RRC_CONNECTED and configured in a BWP without the CSS, the relay WTRU may send a dedicatedSIBRequest with a new indication informing the network that the SI may be broadcast by the network (rather than, or in addition to sending it in dedicated signaling to the relay WTRU). Otherwise (e.g. the SI that is updated does not concern the remote WTRU, or no remote WTRUs requested SI, or relay WTRU configured on a BWP with CSS), the relay WTRU in RRC_CONNECTED may send the legacy dedicatedSIBRequest.

For the example where the relay WTRU may be configured with forwarding behavior for SI, whether a relay WTRU forwards SI to a remote WTRU may be configured to a relay WTRU by the network. For example, a relay WTRU may determine whether to forward SI to a remote WTRU and/or which SI to forward. For example, a relay WTRU may determine from SIB whether to forward SI or not. The relay WTRU may use this configuration, in conjunction with other information (e.g. IC/OOC remote WTRU) to determine whether to forward SI. In another example, a relay WTRU may be configured by the network in dedicated RRC signaling whether/which SI to forward, possibly for each specific attached remote WTRU, possibly for a specific RRC state of the relay/remote WTRU, possibly for a give condition or set of condition described further herein. A relay WTRU follow such configuration only in specific RRC states (e.g. RRC_CONNECTED, RRC_INACTIVE), and may use other rules/procedures herein for the other RRC states. For example, following reception via PC5-RRC of a list of interested SI from the remote WTRU, the relay WTRU may forward any updated SI in that list to the relay WTRU or not based on an indication from the network, which may come to the relay WTRU in dedicated signaling.

Similarly, a remote WTRU may receive similar configuration of whether to send SI and/or receive SI from a relay WTRU or directly on Uu. For example, the remote WTRU may receive such configuration in dedicated RRC signaling while in RRC_CONNECTED, and may apply that configuration also when in RRC_INACTIVE.

A relay WTRU may indicate its support of multipath/single connection by (not) forwarding the SI. As described herein, a relay WTRU may or may not support or be configured for SI forwarding. For example, a relay WTRU which provides an additional path for data routing for a remote WTRU and where the remote WTRU may be anchored on Uu (or another relay which supports SI) may indicate such to the remote WTRU. A relay WTRU may determine whether it supports SI forwarding based on any, or a combination of the following elements.

The forwarding support may be determined based on NW configuration. For example, a relay WTRU may be configured, for example by dedicated signaling, to support/not support SI forwarding. For example, a relay WTRU may be configured to support SI forwarding if the gNB supports multipath (i.e. based on indication in the SIB). For example, a relay WTRU may be configured with a condition (i.e., described herein) on whether to support SI forwarding or not.

The forwarding support may be determined based on WTRU capability. As discussed herein, a relay WTRU may be configured with a capability for providing SI forwarding or not.

The forwarding support may be determined based on Uu RSRP. For example, a relay WTRU may be configured with a minimum and/or maximum Uu RSRP for which to support SI forwarding or not.

The forwarding support may be determined based on relay load. For example, a relay WTRU may measure a load metric based on any of resources used, number of remote WTRU connections, number of bearers used, overall traffic forwarded, etc. If the relay WTRU's measured load is below a specific amount the relay WTRU may support SI forwarding.

The forwarding support may be determined based on BWP configuration. For example, if the relay WTRU is configured with a BWP that includes the common search space, it may decide to support SI forwarding.

The forwarding support may be determined based on power savings preference or configuration at the relay WTRU. For example, whether the relay WTRU supports SI forwarding may depend on the value of a DRX configuration parameter (e.g., DRX cycle is larger/smaller than an offset, DRX offset having some value relative to SI modification period). For example, whether the relay WTRU supports SI forwarding may depend on its power consumption characteristics and/or battery life.

The forwarding support may be determined based on RRC state of the relay WTRU. For example, whether the relay WTRU supports SI forwarding may be dictated by the RRC state of the relay WTRU.

The forwarding support may be determined based on services and/or bearers/QoS configured at the relay WTRU. Specifically, whether the relay WTRU supports SI forwarding may be a function of the services currently being supported by the relay WTRU, the bearers configured at the relay WTRU, or the QoS of the services supported/forwarded by the relay WTRU. For example, the relay WTRU may support SI forwarding as long as the number of bearers configured with a priority higher than a threshold is below another threshold. For example, the relay WTRU may support SI forwarding if one or more relayed RLC channels at the relay WTRU are configured with a property (e.g., explicit, or implicit, such as priority) for which the relay WTRU configured to forward SI.

A relay WTRU that supports SI forwarding may indicate such to the remote WTRU. The relay UE may include SI or some specific SI (e.g. cell access information) in the discovery message transmitted by the relay WTRU. If the relay WTRU does not support SI forwarding, it may not include the cell access information in the discovery message. The relay WTRU may, upon reception of an SI request by the remote WTRU, indicate that whether or not it supports SI forwarding. The relay WTRU may inform the remote WTRU in a PC5-RRC message that it supports or does not support SI forwarding.

The relay WTRU may trigger the signaling change described above upon a change in the conditions for supporting SI forwarding.

As described herein, a remote WTRU that is PC5-RRC connected to a relay WTRU which does not support SI forwarding may request/acquire SI (potentially in RRC_IDLE/RRC_INACTIVE) from the Uu link or from another link, when connected via multipath. In one example solution, a remote WTRU may (re) select relay WTRUs which only support SI forwarding for initiation of an RRC connection via a relay WTRU.

In an example, a remote WTRU that is PC5-RRC connected to a relay WTRU may trigger a re-establishment when a relay WTRU changes its support of SI forwarding to “not supported” if it is connected via the relay WTRU, or if it is connected via multipath and the Uu link experiences RLF.

In another example, a remote WTRU that is PC5-RRC connected to a relay WTRU may trigger relay (re) selection (possibly immediately, possibly upon the next transition of the remote UE to RRC_IDLE/RRC_INACTIVE) when the relay WTRU changes its support of SI forwarding to “not supported”. Specifically, the remote WTRU may trigger a mobility procedure upon change in SI forwarding support to “not supported” when the remote WTRU is in RRC_IDLE/RRC_INACTIVE.

For the example where the contents of the SI Request from Remote WTRU to Relay WTRU, a remote WTRU may send SI request to a relay WTRU. A remote WTRU may also send SI forwarding enable/disable message to the relay WTRU to enable/disable the relay WTRU to forward SI when SI update is triggered. The two messages may be implemented in a single message.

The remote WTRU may include the following in any of an SI request or SI forward enabled/disable message: Uu/SL quality measured by the remote WTRU (either actual quality or in the form of a quality level, or indication of whether the quality is above or below a threshold), indication of RRC state of the remote WTRU, indication of the remote WTRU coverage status (IC/OOC), indication/request of whether SI may be forwarded, or whether the remote WTRU will acquire the SI directly from Uu including the remote WTRU may use other examples of information sent to the relay WTRU instead to compute this indication, the Cell ID of the cell for which the remote WTRU would need SI, the list of SI(s) that the remote WTRU requests forwarding compared to the SIs which the remote WTRU acquires directly via Uu, indication/request of whether the SI modification request by the network may be forwarded or not by the relay WTRU to the remote WTRU, a validity time period that indicates how long the relay WTRU may take to forward any modified SI, area ID or validity tag of the SI currently at the remote WTRU, and number of hops (in the case the request is being made by an intermediate node also connected to a remote WTRU in multihop architecture).

In one example, a remote WTRU may use two different indications to the relay WTRU for SI forwarding behavior, or may indicate three different SI reception behavior to be taken by the relay WTRU. Specifically, the remote WTRU may in one case receive all SI modification (i.e., via paging) and SI via Uu, and may indicate such to the relay WTRU. In another example, the remote WTRU may indicate that it may not receive SI modification (i.e. paging) via Uu, and may rely on the relay WTRU, however, it may receive updated SI via the network (e.g., through detection of SIB1, of after indication by the relay WTRU). In another example, the remote WTRU may indicate that it receives both SI modification and updated SI via the relay WTRU only.

The relay WTRU may perform one or a combination of different actions depending on each of the three possible cases above, indicated by potentially two separate indications from the remote WTRU.

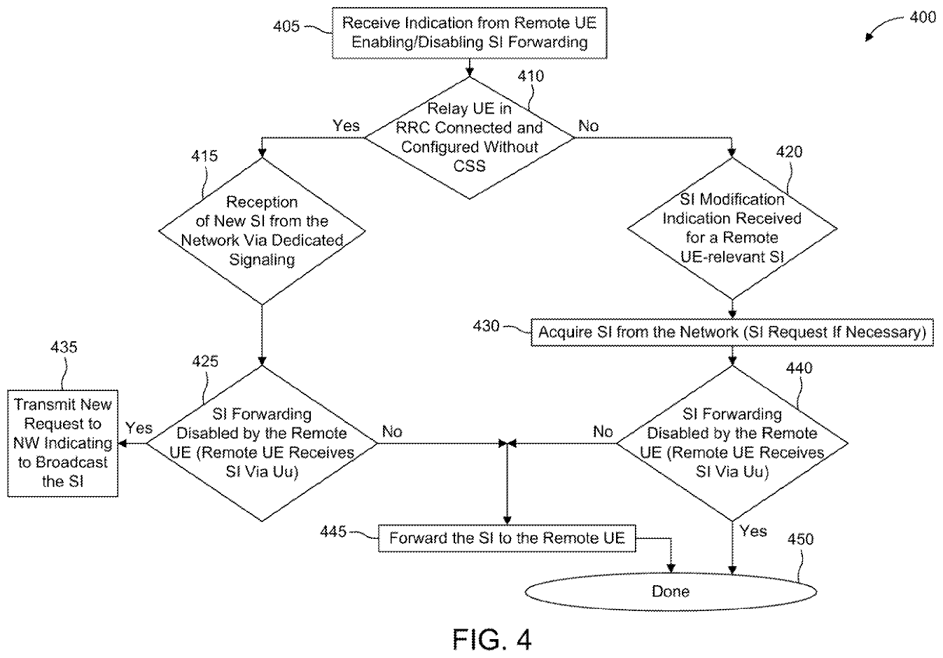

FIG. 4 illustrates a method 400 for system information acquisition for multipath WTRU to NW relays. The multipath WTRU include the features described above as needed to perform method 400.

Method 400 includes, at 405, receiving an indication from a remote WTRU enabling or disabling SI forwarding. Method 400 includes, at 410, determining if the relay WTRU connected to one or more remote WTRUs may receive a PC5-RRC message from a remote WTRU which either enables or disables SI forwarding of SL for that remote WTRU.

Method 400 includes, at 420, when the relay WTRU is not connected and configured without CSS, the SI modification indication is received for a remote WTRU relevant SI. At 430, method 400 includes acquiring an SI from the network. This acquisition may include an SI request if necessary. At 440, method 400 includes disabling SI forwarding by the remote WTRU. This disabling allows the remote WTRU to receive SI via Uu. If the SI forwarding is disabled in 440, method 400 may be completed at 450. If the SI forwarding is not disabled at 440, method 400 includes forwarding the SI to the remote US at 445 before completing method 400 at 450.

Method 400 includes, at 415, when the relay WTRU is connected and configured without CSS, receiving a new SI from the network via a dedicated signaling, for example. At 425, method 400 includes disabling SI forwarding by the remote WTRU. This disabling allows the remote WTRU to receive SI via Uu. If the SI forwarding is disabled in 425, method 400 transmits a new request to NW indicating to broadcast the SI at 435. If the SI forwarding is not disabled at 425, method 400 includes forwarding the SI to the remote US at 445 before completing method 400 at 450.

For example, method 400 may include the relay WTRU may receive one or more SI requests from a remote WTRU and may remember the SIs which are of interest for each remote WTRU. Upon reception, by the relay WTRU, of a new SIB (i.e., in dedicated signaling from the network, in the case the relay WTRU is configured in RRC_CONNECTED with a BWP without CSS), or upon reception by the relay WTRU of an SI modification, the relay WTRU may first check if it needs to act based on whether the modified SI is associated with an SI which is of interest to one of the remote WTRUs. The relay WTRU may act when a remote WTRU requires the SI which is modified. The action taken by the relay WTRU may depend on its RRC state. Specifically, if the relay WTRU is in RRC connected, the relay WTRU may send a dedicateSIBRequest message to the network if the SIB is required. If the relay WTRU is configured on a BWP without CSS and at least one relay has SIB forwarding disabled via SL, the relay WTRU may send an SI request (e.g. an indication along with the dedicatedSIBRequest) to request the network to broadcast the SIB, otherwise, the relay WTRU in RRC connected may send the legacy dedicatedSIBRequest message (or the message without activating the indication). The relay WTRU in IDLE/INACTIVE may send the normal SI request if the relay WTRU may act. Regardless of the RRC state, the relay WTRU may forward the SI to a remote WTRU if the remote WTRU requested SI forwarding. Without loss of generality, the relay WTRU message to the network to initiate SI broadcasting by the network of an SI may be any RRC message (not only dedicatedSIBRequest), or any uplink transmission, such as a RACH procedure (similar to MSG1-based SI request), etc. Such a transmission may allow the network to transmit SI that is not currently being broadcast. In addition, a relay WTRU, before transmission of such a message as illustrated in FIG. 4, may first determine if the SI which has been updated, is currently being broadcast by the network or not (by checking the contents of SIB1), and may only transmit such message when the network is not broadcasting the specific SIB that has been updated.

In an example, the relay WTRU may decide a unified approach to SI forwarding based on the individual coverage status and request from each remote WTRU. For example, if all remote WTRUs are in coverage, the relay WTRU may not perform SI forwarding (and rely on Uu SI transmission) regardless of the request by some individual WTRUs. Specifically, the relay WTRU may reject the request to forward the SI by the remote WTRU. In an example, if at least one remote WTRU indicates to the relay WTRU that it is OOC and in RRC_IDLE, RRC_INACTIVE, the relay WTRU may perform forwarding SI over SL for all WTRUs regardless of whether they requested it or not.

FIG. 5 illustrates a method 500 for system information acquisition for multipath WTRU to NW relays. The multipath WTRU include the features described above as needed to perform method 500.

Method 500 includes two main elements where the IC remote WTRU requests SI at 510 and a relay WTRU providing SI at 550. Within the IC remote WTRU requests SI at 510, method 500 includes receiving from the network in SIB1 an SI request transmission threshold, a SI acquisition threshold and a SI request configuration. The SI request configuration may include either of MSG1 or MSG3. The Uu quality is compared to the SI request transmission threshold and it is determined if the SI request configuration is MSG3 at 525. If the comparison or determination at 525 result in no, at 535, the legacy Uu is followed to request and receive SI via Uu. If the comparison or determination result in yes, at 545, a computation of IC/OOC indications is performed and sent to the relay WTRU with the SI request.

Within the relay WTRU providing SI at 550, method 500, at 555, includes requesting the SI on behalf of the remote WTRU. At 565, method 500 includes a determination if the remote WTRU IC or relay WTRU in IDLE/INACTIVE. If the determination at 565 results in no, at 575, the legacy SL relay is used to forward the SI to the remote WTRU. If the determination at 565 results in yes, at 585, the remote WTRU is informed that the SI will be available via Uu.

Details and modifications related to methods 400, 500 are provided below. For example, the Uu quality measured by the remote WTRU and the RRC state of the relay WTRU may determine the SI forwarding/acquisition behavior of the remote and relay WTRU. Specifically, the remote WTRU may receive in SIB1 an SI request transmission threshold and an SI acquisition threshold. The remote WTRU may further receive an SI request config (as per legacy) which determines whether a WTRU performs MSG1 or MSG3-based SI request. If the remote WTRU is in coverage, and in the case where the Uu quality of the remote WTRU is below a request threshold and the remote WTRU is configured with MSG3-based SI request, the remote WTRU may send the SI request to the relay WTRU. Otherwise, the SI request may be sent via Uu. If the SI request is sent via Uu, the remote WTRU may also receive SI via Uu using legacy procedures. If the SI request is sent via SL to the relay, the remote WTRU may include an IC/OOC indication to the relay WTRU. The IC/OOC indication may be computed based on the current conditions for a suitable cell. Alternatively, the IC/OOC indication may be computed by comparing the Uu quality with a new threshold.

The relay WTRU, in the case the relay WTRU receives an SI request from the remote WTRU, may request SI on behalf of the remote WTRU if the relay WTRU does not currently have a valid version of the SI, and the network is not currently broadcasting the SI requested. If the remote WTRU has indicated IC, and the relay WTRU is in IDLE/INACTIVE, the relay WTRU may inform the remote WTRU to receive the SI via Uu. Otherwise, the remote WTRU may forward the requested SI (that it had or may have acquired) to the remote WTRU.

In a modified example of the example illustrated in FIG. 5, the relay WTRU itself may not require the SI requested by the remote WTRU. If the relay WTRU determines to have the remote WTRU acquire the SI itself, the relay WTRU may perform a request without acquisition of the SI as described herein.

The present system and method handle SI modification indication and PWS. SI modification indication and PWS indication are described interchangeably, as the indication is sent by the network using a common paging message. It may be understood that the ideas apply to the network transmitting either a paging message indicating that SI has changed, or a paging message indicating the PWS is being broadcast, or a paging message indicating both. SI modification indication (i.e., in paging) may be received by a remote WTRU. A remote WTRU may receive such indication over Uu, for example, if the remote WTRU is in multipath and monitoring paging on Uu. Alternatively, a remote WTRU may receive such indication of PC5 from the relay WTRU.

If the SI modification indication forwarding may be enabled/disabled at the relay, a remote WTRU may send a request to receive SI modification indication/PWS indication from a relay WTRU. The conditions for sending such request may be related to any of the conditions described herein for determining whether SI request is sent via Uu or PC5 or conditions for which SI is to be received over Uu or PC5. For example, the remote WTRU may request to receive SI modification indication/PWS indication from a relay WTRU in case any or a combination of the following: the measured RSRP on Uu is below a threshold, the measured SL RSRP is above a threshold, and the remote WTRU is in coverage of the same cell as the cell to which the relay is connected/camped. Alternatively, a relay WTRU may be configured by the network whether or not to forward SI modification to the remote WTRU (either a specific remote WTRU or all remote WTRUs) either in dedicated RRC signaling or in SIB.

The present system and method may operate with remote WTRU actions when receiving SI modification indication. A remote WTRU, following reception of SI modification indication, may perform any of the following: receive SIB1 from the network, request/receive SIB1 from the relay WTRU, always receive SI via Uu, possibly starting at the next modification period, always receive SI via SL, possibly starting at the next modification period, request SI to the relay WTRU, decide whether to receive SI from SL or from Uu, possibly based on decision criteria described herein, determine whether to receive SI via SL or Uu, based on criteria described herein, receive SI via SL (or Uu), and upon failure of reception on SL (or Uu), start reception of SL via Uu (or SL), and inform the relay WTRU whether to receive SI via SL or not.

For receive SIB1 from the network, for example, if the remote WTRU receives SI modification from Uu, it may receive SIB1 from Uu. The remote WTRU may further determine which subsequent action to take based on the contents of SIB1 (e.g. the modified SIB and/or whether the modified SIB is being broadcast or not).

For request/receive SIB1 from the relay WTRU, for example, if the remote WTRU receives SI modification from Uu, it may request/receive SIB1 from the relay WTRU to determine which SI has changed. The remote WTRU may further determine which subsequent action to take based on the contents of SIB1 (e.g. the modified SIB and/or whether the modified SIB is being broadcast or not). The remote WTRU may always request SIB1 following reception of SI modification. Alternatively, the remote WTRU may assume the relay WTRU will forward SIB1 automatically following SI modification. The remote WTRU may wait for updated SIB1 from the relay WTRU for a period of time, and if not received, may request SIB1 from the relay WTRU.

The remote WTRU may receive SI via Uu, possibly starting at the next modification period.

For the always receive SI via SL, possibly starting at the next modification period, for example, a remote WTRU may always receive/request SI via SL, and the remote WTRU may use Uu only for SI modification indication reception (for example, to know when it may start monitoring SL in case of SL DRX like operation)

The remote WTRU may request SI to the relay WTRU.

The remote WTRU may decide whether to receive SI from SL or from Uu, possibly based on decision criteria described herein.

The remote WTRU may determine whether to receive SI via SL or Uu, based on criteria described herein.

For receive SI via SL (or Uu), and upon failure of reception on SL (or Uu), start reception of SL via Uu (or SL), failure may include of any of the following: expiry of a time period while waiting to receive the SI. Specifically, a remote WTRU may, upon reception of SI modification indication on Uu, start a timer and start monitoring SL for SI reception over sidelink for a period of time. If SI is not received following expiry of the time period, the WTRU may start monitoring Uu for the updated SI (which may involve performing an SI request). In another example, a remote WTRU may, upon reception of SI modification (possibly on Uu), start a timer and start monitoring SL for SI reception over sidelink. If SI is not received prior to expiration of the time period, the WTRU request the required SI either via SL or Uu (possibly based on the criteria for decision herein).

For inform the relay WTRU whether to receive SI via SL or not, for example, the remote WTRU may decide to receive SI (following SI modification) via Uu, and may indicate such to the relay WTRU. The relay may, as a result, avoid forwarding any SI to the remote WTRU as a result of the SI modification.

In an example where a remote WTRU determines whether to request SI from relay following SI modification, a remote WTRU (e.g., following reception of the SI modification via Uu) may determine whether to perform a request for SI to a relay WTRU (or whether to just receive the SI from the relay WTRU without request) based on any or a combination of the following: the type of SI, or specific SI that is being modified and whether the remote WTRU performed a request previously while SI forwarding was enabled at the relay WTRU.

For the type of SI, or specific SI that is being modified, for example, a remote WTRU may request certain SI from the relay WTRU following SI modification indication reception, while it may not request other SI following reception of the indication. For example, for PWS, the remote WTRU may not request the SI and wait to receive the SI. For other SIBs, the remote WTRU may immediately request the SI from the relay WTRU

For whether the remote WTRU performed a request previously while SI forwarding was enabled at the relay WTRU, for example, a remote WTRU may send a message to a relay WTRU enabling/disabling SI forwarding. Specifically, a remote WTRU may enable SI forwarding when it is in RRC_IDLE/RRC_INACTIVE or moves out of coverage. The remote WTRU may disable SI forwarding when the remote WTRU moves in coverage or the remote WTRU transitions to RRC_CONNECTED. A remote WTRU may determine whether SI request is required to the relay WTRU following SI modification based on whether the remote WTRU has requested SI to the relay WTRU for the SI that was changed by the network since the last time SI forwarding was enabled at the relay WTRU. Specifically, if a particular SI/SIB has changed, and the said SI/SIB was requested to the relay since the last time SI forwarding was enabled, the remote WTRU may not request the SI following SI modification. The remote WTRU may wait for the SI to be forwarded by the relay WTRU (such behavior may further be dependent on a period, as described herein). On the other hand, if the particular SI/SIB has changed, and the said SI/SIB was not requested to the relay since the last time SI forwarding was enabled by the remote WTRU to the relay, the remote WTRU may immediately request the SI/SIB which has changed. The remote WTRU may determine which SI/SIB needs to be reacquired as a result of the received SI modification based on SIB1, which may be received from the relay WTRU, or directly from Uu.

The present system and method handle race conditions between SI modification indication and update SI. A relay WTRU in RRC_CONNECTED may receive updated SI from the network in dedicated signaling, and may forward the updated SI to the remote WTRU prior to the network signaling the SI modification via paging. The remote WTRU that may receive SI modification may unnecessarily trigger a procedure to acquire the same SI twice.

In order to handle the race condition between SI modification indication and update SI, the remote WTRU may ignore SI modification indications in some conditions. For example, a remote WTRU may ignore an SI modification indication received via Uu. Specifically, a WTRU may perform an SI acquisition procedure following reception of an SI modification indication as long as any of the following (or combination of such) is not satisfied including the remote WTRU receives updated SI from a relay WTRU, possibly within a period of time, the SI modification indication is for PWS, and the remote WTRU does not receive an indication to ignore further SI modification.

For the remote WTRU receives updated SI from a relay WTRU, possibly within a period of time, for example, a remote WTRU may ignore any SI modification indication and not perform any SI acquisition for a period of time T following the reception of updated SI from the relay WTRU.

For the SI modification indication is for PWS, for example, a remote WTRU may ignore SI modification indication for a period of time after reception of updated SI from the relay, as long as the SI modification is not for PWS. In the case of PWS indication, if the remote WTRU has not already received PWS from the relay WTRU in that same time period, the remote WTRU may perform SI acquisition following reception of SI modification indication.

For the remote WTRU does not receive an indication to ignore further SI modification, for example, a remote WTRU may ignore SI modification indication following reception of SI from the relay WTRU as long as the remote WTRU receives/does not receive an indication from the relay WTRU. Similarly, the relay WTRU may send/not send such indication if it receives updated SI from the network in dedicated RRC signaling (otherwise, the relay may not/may send such indication). The relay WTRU may provide the indication along with the updated SI on sidelink.

The remote WTRU may decide to request/receive SI via Uu. For example, a remote WTRU may ignore SI modification indication following reception of paging when the remote WTRU requests/receives SI from the relay WTRU (where the decision of such may be based on conditions herein). In these cases, the remote WTRU may rely on the relay WTRU to obtain the modified SI.

The cell to which the remote WTRU and the relay WTRU are connected may be the same, and the PCell is the cell via the relayed path. For example, a remote WTRU may ignore SI modification indication received via Uu when the cell ID on the direct and indirect path are different, and the remote WTRU is assumed to receive SI via the indirect path. On the other hand, if the cell IDs are the same, or the PCell of the remote WTRU is assumed to be the cell of the direct path, when the remote WTRU receives SI modification, it may initiate an SI request procedure, or acquire new SI.

This may further be conditioned on the type of SI. Specifically, for ETWS/CMAS, the remote WTRU may receive the SI following reception of the SI modification indication, regardless of the whether the paths correspond to the same/different cells and which path corresponds to the PCell.

In order to handle the race condition between SI modification indication and update SI, the relay WTRU may delay forwarding of SI to the remote WTRU. For example, a relay WTRU may delay forwarding of updated SI to a remote WTRU. The remote WTRU may determine the amount of delay and/or whether to delay the SI based on one or a combination of the following factors: the method in which the relay WTRU acquired/received the SI from the network, based on indication/configuration from the network, the modification period of the SI, whether the SI being forwarded was originally being broadcast by the network, or whether an SI request was required, and the specific SI or SI type (e.g., specific SIB or whether SI is PWS, etc.).

For the method in which the relay WTRU acquired/received the SI from the network (e.g. dedicated signaling, using SI request, using acquisition of broadcast after reception of SI modification, using MSG1 or MSG3, etc.). For example, the relay WTRU may delay forwarding of SI to the remote WTRU if the SI is received from the network via dedicated signaling. Otherwise (i.e. the relay received the SI following reception of the SI via broadcast signaling, or following an SI request to the network), the relay WTRU may not delay the SI.

In basing on indication/configuration from the network, for example, the relay WTRU may receive an indication in dedicated signaling (possibly along with the updated SI) to forward the SI to the remote WTRU at a later time. The relay WTRU may also receive the amount of time to delay forwarding of the SI directly from the network

For the modification period of the SI, for example, the relay WTRU may decide to delay forwarding of any acquired SI from the network to the remote WTRU by a certain an amount of time that is a function of the SI modification period of the received SI. For example, the relay WTRU may wait for at least one modification period. For example, the relay WTRU may wait until the time in which the next modification period starts.

Whether the SI being forwarded was originally being broadcast by the network, or whether an SI request was required may be included.

For the specific SI or SI type (e.g. specific SIB or whether SI is PWS, etc.), for example, the relay WTRU may decide to delay one SIB/SI, and not delay another SIB/SI. Specifically, if a particular SI is updated based on modification period (e.g. non-PWS), the relay WTRU may delay forwarding of the SIB.

In order to handle the race condition between SI modification indication and update SI, a relay WTRU may indicate to the remote WTRU when to acquire the SI on Uu. In one example, a relay WTRU, in addition to indicating that the remote WTRU may acquire modified SI on Uu, may inform the remote WTRU of when the acquisition may begin. In one example, the relay WTRU may indicate whether SI acquisition may be started immediately, or at the next SI. For example, if the relay receives SI modification indication indicating PWS, or another SI which is updated immediately by the network following SI modification, the relay WTRU may indicate to the remote WTRU that it may acquire the SI immediately. If the relay WTRU receives SI modification indication for an SI that is updated based on modification period, the relay WTRU may indicate to the remote WTRU to acquire the SI at the next modification period. In another example, the relay WTRU may provide the absolute/relative time when the remote WTRU may acquire the updated SI on Uu. For example, the relay WTRU may, if the updated SI is provided at the next modification period, provide the timing of the start of the next modification period to the remote WTRU.

In another example, the relay WTRU may provide an indication of the time in which the network-initiated SI broadcast following SI request by the relay WTRU. Specifically, a request by the remote WTRU to the relay WTRU may trigger an SI request by the relay WTRU to the network. The relay WTRU may inform the remote WTRU of when the SI may be broadcast by the network. Specifically, the relay WTRU may wait until the SI request to the network is successful (the requested SI is being broadcast by the network) to send an acknowledgement to the remote WTRU that SI is being broadcasted. Alternatively, the relay WTRU may determine an expected time when it will send SI request, and may provide the expected time when SI broadcast will start to the remote WTRU (immediately following the remote WTRUs SI request to the relay).

The remote WTRU may follow the indication received from the relay WTRU to determine when to trigger SI acquisition on Uu.

Although features and elements are described above in particular combinations, one of ordinary skill in the art will appreciate that each feature or element may be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a UE, WTRU, terminal, base station, RNC, or any host computer.

1. A method, implemented by a wireless transmit/receive unit (WTRU), the method comprising:
receiving configuration information, wherein the configuration information comprises information regarding a first discontinuous reception (DRX) cycle with a first periodicity and a second DRX cycle with a second periodicity, wherein the configuration information comprises a time offset value (T), wherein the configuration information comprises a threshold value for wake-up signal (WUS) detection, and wherein the configuration information comprises a number (N) of monitoring occasions for missed WUS detections;
monitoring for a WUS according to the first periodicity;
monitoring for a paging indication according to the second periodicity;
on a condition that a WUS is not detected, monitoring for the paging indication according to the first periodicity, and receiving the paging indication; and
transmitting data over a physical random access channel (PRACH).

2. The method of claim 1, further comprising:
determining that the WUS is not detected by determining that a measurement of the WUS is less than the threshold value for WUS detection for N consecutive monitoring occasions.

3. The method of claim 2, further comprising monitoring for the paging indication according to the first periodicity after the time offset value (T) from a time of the Nth consecutive monitoring occasion.

4. The method of claim 1, wherein the second periodicity is longer than the first periodicity.

5. The method of claim 1, wherein the WUS signal is a low power WUS.

6. The method of claim 1, wherein the WTRU monitors for the WUS using a low power wake-up receiver (WUR).

7. The method of claim 1, wherein the WUS has a first waveform type, wherein the first waveform type is non-orthogonal frequency division multiplexing (non-OFDM).

8. The method of claim 1, wherein the paging indication is received via a second waveform type, wherein the second waveform type is orthogonal frequency division multiplexing (OFDM).

9. The method of claim 1, wherein the WTRU monitors for the paging indication using a main transceiver.

10. The method of claim 1, wherein the paging indication is received in a downlink control information (DCI) over a physical downlink control channel (PDCCH).

11. A wireless transmit/receive unit (WTRU) comprising:
a low power wake-up receiver (WUR); and
a main transceiver, wherein:
the main transceiver is configured to receive configuration information, wherein the configuration information comprises information regarding a first discontinuous reception (DRX) cycle with a first periodicity and a second DRX cycle with a second periodicity, wherein the configuration information comprises a time offset value (T), wherein the configuration information comprises a threshold value for wake-up signal (WUS) detection, and wherein the configuration information comprises a number (N) of monitoring occasions for missed WUS detections;
the WUR is configured to monitor for a WUS according to the first periodicity;
the main transceiver is further configured to monitor for a paging indication according to the second periodicity;
the main transceiver is further configured to, on a condition that a WUS is not detected, monitor for the paging indication according to the first periodicity, and receive the paging indication; and
the main transceiver is further configured to transmit data over a physical random access channel (PRACH).

12. The WTRU of claim 11, further comprising a processor configured to determine that the WUS is not detected by determining that a measurement of the WUS is less than the threshold value for WUS detection for N consecutive monitoring occasions.

13. The WTRU of claim 12, wherein the main transceiver is further configured to monitor for the paging indication according to the first periodicity after the time offset value (T) from a time of the Nth consecutive monitoring occasion.

14. The WTRU of claim 11, wherein the second periodicity is longer than the first periodicity.

15. The WTRU of claim 11, wherein the WUS signal is a low power WUS.

16. The WTRU of claim 11, wherein the WUS has a first waveform type, wherein the first waveform type is non-orthogonal frequency division multiplexing (non-OFDM).

17. The WTRU of claim 11, wherein the paging indication is received via a second waveform type, wherein the second waveform type is orthogonal frequency division multiplexing (OFDM).

18. The WTRU of claim 11, wherein the paging indication is received in a downlink control information (DCI) over a physical downlink control channel (PDCCH).

19. The WTRU of claim 11, wherein the main transceiver is further configured to perform radio resource management measurements.

20. The WTRU of claim 11, wherein the main transceiver is configured to be in a sleep mode when the WUR is monitoring for the WUS.
